(19) United States
(12) Patent Application Publication
(10) Pub. No.: US 2015/0193023 A1
(43) Pub. Date: Jul. 9, 2015

(54) DEVICES FOR USE WITH COMPUTERS

(71) Applicant: Swiftpoint Limited, Christchurch (NZ)

(72) Inventors: Grant Neville ODGERS, Little River (NZ); William EARLY, Mosgiel (NZ); Simon THIRD, Christchurch (NZ); David BEACH, Christchurch (NZ)

(73) Assignee: Swiftpoint Limited, Christchurch (NZ)

(21) Appl. No.: 14/594,493

(22) Filed: Jan. 12, 2015

Related U.S. Application Data
(63) Continuation-in-part of application No. 13/685,653, filed on Nov. 26, 2012.
Application No. 13/685,653 is a continuation of application No. 11/815,094, filed on Dec. 2, 2008.
Application No. 11/815,094 is a continuation-in-part of application No. PCT/IB2013/055772, filed on Jul. 12, 2013.

(30) Foreign Application Priority Data
Jan. 5, 2005 (NZ) 535766
Jul. 12, 2012 (NZ) 601229
May 14, 2013 (NZ) 610609

(51) Int. Cl. G06F 3/0354

(52) U.S. Cl. CPC G06F 3/03543

(57) ABSTRACT

A computer mouse for use with a computer, including: a base with a lower surface configured for sliding across a work surface and having at least one portion forming part of a base contact plane; an upper body extending from the base; a contact sensor; an optical movement sensor system capable of detecting mouse movement relative to the work surface, a communication system, for communicating computer-readable movement and/or position data signals from the device to a computer, wherein the mouse is configured to operate in a first mode when orientated in a first orientation, and a second mode when orientated in a second orientation when the base contact plane is inclined with respect to the first orientation, and wherein the optical movement sensor system is configured to capture an image of the work surface in both the first and second modes to determine device movement in both modes.

### CROSS-REFERENCE TO OTHER APPLICATIONS

This is a continuation-in-part of International Patent Application No: PCT/IB2013/055772, filed on Jul. 12, 2013, which claims priority from New Zealand Patent Application No. 601229, filed on Jul. 12, 2012 and New Zealand Patent Application No. 610609, filed May 14, 2013; and is a continuation-in-part of U.S. patent application Ser. No. 13,685,653 filed on Nov. 26, 2012, which is a continuation of U.S. patent application Ser. No. 11/815,094, filed on Dec. 2, 2008, which is a National Phase of International Application No. PCT/NZ2006/000007, filed on Jan. 30, 2006, which claims priority from New Zealand Patent Application No. 535766, filed on Jan. 30, 2005, all of which are incorporated herein by reference in their entirety.

### TECHNICAL FIELD

The present invention relates generally to improvements in devices for use with computers. In particular the present invention relates generally to an improved computer mouse, a configurable device for use with a computer and a method of configuring the devices.

### BACKGROUND ART

Computer mice and keyboards are the most widely used computer peripherals used to control a computer and manipulate data input and output and are deemed essential by many people to effectively use a computer. However, advances in touch-screen technology and miniaturisation of computer components have led to the widespread adoption of touch-controlled fully functional small portable computers such as smart phones and tablets.

Examples of common touch screen controls and examples of their function in the computer operating system are shown in the following table.

| Control | User finger action | Operating system interpretation |
|---|---|---|
| Tap or | brief touch of finger on | The operating system typically interprets a tap as |
| select | the touch-screen | a selection of a GUI element, e.g. tapping on an |
| | | application icon will launch the application. Two or |
| | | more taps in quick succession offer additional |
| | | functionality such as selecting entire words, |
| | | sentences or zooming. |
| long press | placement of finger on | The operating system typically interprets a long |
| | the screen for longer | press as a request for access to a contextual |
| | than a threshold time | menu associated with the GUI element selected in |
| | indicating a tap. | the tap. |
| swipe | movement of finger over | The operating system typically translates a swipe |
| | the touch-screen while in | into movement of GUI pages, screens or |
| | contact. | windows. Typical movements include panning |
| | | (vertical and/or horizontal movement) scrolling |
| | | (rapid vertical movement), flick (rapid horizontal |
| | | movement) e.g. an upwards/downwards swipe |
| | | may result in vertical scrolling of the GUI element |
| | | while a sideways flick may result in BACK or |
| | | FORWARD command in a web browser or |
| | | flipping of pages in an e-book. |
| drag | a long press followed by | Movement of the finger following a long press |
| | a swipe | may result in movement of the selected GUI |
| | | element. |
| Pinch or | Two fingers are brought | Typically a pinch is interpreted as a zoom-in |
| spread | together (pinch) or apart | command (fingers together) and a spread as a |
| | (spread). | zoom-out command (fingers apart). |
| rotate | Two fingers are placed | a rotate command typically results in rotation of |
| | on screen and moved in | the GUI element. |
| | opposite arcuate | |
| | directions about a | |
| | central point. | |

Many users find the finger manipulation of such a touch-screen more intuitive than using a mouse and keyboard for many tasks. However, touch-screen keyboards are not as efficient as a keyboard for entering large volumes of text and so many users may use a separate keyboard to enter data on a touch-screen controlled computer to assist in data entry. Moreover, if frequent manipulation of the touch-screen is required the user's fingers will frequently occlude on-screen items which may frustrate the user. Thus in such a ‘productive’ mode many users instead use the touch-screen primarily for viewing and connect a separate keyboard and mouse to the touch-screen computer with the keyboard used for data entry and the mouse used for on-screen manipulation of Graphical User Interface (GUI) objects.

The intuitive control gestures of touch-screen operating systems may also be useful in a conventional desktop or laptop working environment and recent Windows® operating systems (version 7 and 8) have been designed to work with touch-screen inputs. Thus, it can be seen that the use of touch-screens and touch-screen control methods are likely to increase as the prevalence of mobile ‘smart’ phones and tablet devices increases.

However, touch-screen operating systems are primarily designed for touch-input and thus many touch controls are not as easily performed by a mouse or keyboard combination, making it difficult for users to benefit from the intuitive touch-screen controls while using keyboard and mouse. The swipe gesture for example is typically emulated using a mouse by holding a button down (e.g. left-click) while moving the mouse. This method is unintuitive for many people and strains a user's hand as they must grip the mouse to move it while placing pressure on a button.

It would therefore be advantageous to provide a mouse that offers a more intuitive mode of operation for use with a touch-screen optimised operating system or for providing touch-screen type inputs to a conventional computer operating system.

Computers typically require software ‘drivers’ to interface with a connected device. These drivers may be generic drivers suited to a wide range of devices (e.g. generic mouse drivers for MS Microsoft Windows) or unique drivers for that device that provide enhanced functionality and/or allow the device to be configured via the computer, e.g. a mouse driver software may allow configuration of mouse function parameters, such as choosing button functions or mouse pointer acceleration.

However, the use of unique drivers for devices can be a burden for users as they must install the software before they can configure and/or use their device.

To overcome some of this hindrance, some advanced devices have onboard memory and configuration controls enabling the user to change device parameters by pressing button combinations or the like.

However, most devices have no display screen and so it can be difficult for a user to determine how to configure the device and what changes they have made to the device. Often the user is required to refer to a user manual to determine which sequence or combination of buttons to press to change a particular configuration option.

It would thus be advantageous to provide a method of configuring a device via a computer without need for unique drivers.

It is an object of the present invention to address the foregoing problems or at least to provide the public with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to a preferred aspect, the present invention includes a computer mouse for use with a computer, said computer mouse including:
a base with a lower surface configured for sliding across a work surface, said lower surface having at least one portion forming part of a base contact plane;
an upper body, extending from the base;
at least one contact sensor;
a movement sensor system, capable of detecting mouse movement relative to said work surface;
a communication system, for communicating computer-readable movement and/or position data signals from the device to a computer, said movement data signals indicating said detected mouse movement and said position data signals indicating a position of the mouse characterised in that the mouse is configured to operate in a first and second modes.

Preferably, said computer mouse is configured to operate in
a first mode when orientated in a first orientation, and
a second mode when orientated in a second orientation where said base contact plane is inclined with respect to said first orientation.

Preferably, said movement sensor system is configured to detect device movement and/or position relative to said work surface in both the first and second modes.

Preferably, wherein said movement sensor system is an optical movement sensor system including:
a light source configured to illuminate the work surface, and
an image sensor or array, configured to receive reflected light from said work surface to capture an image of the work surface, wherein successive captured images are compared to determine device movement.

Preferably said image sensor or array is configured to capture an image of the work surface in both the first and second modes, wherein successive captured images are compared to determine device movement in both the first and second modes.

According to a further aspect, the present invention further includes at least one mode sensor configured to initiate a said mode, wherein said light source is configured to illuminate the work surface at or adjacent said mode sensor.

According to a further aspect, the present invention includes at least one mode sensor configured to initiate a said mode.

Preferably, said mouse is configured to operate in
said first mode when orientated in a first orientation, and
said second mode when orientated in a second orientation where said base contact plane is inclined with respect to said first orientation and a said mode sensor is configured to initiate said first or second mode when the mouse is in said first or second orientation respectively.

According to a further aspect, said mode sensor is configured to initiate said second mode when the mode sensor contacts the work surface.

Preferably, the mode sensor is configured to initiate said second mode when the mode sensor is pressed against the work surface.

Preferably, the mode sensor includes a projection extending towards said base contact plane.

Preferably, the mode sensor projection is located above the base contact plane.

Preferably, the mode sensor projection is releasably connected to the computer mouse.

According to a further aspect, the mode sensor projection has an outer contact surface for contacting the work surface, the outer contact surface being releasably connected.

Preferably, said mouse includes a scroll wheel, the scroll wheel including a mode sensor.

Preferably, at least one contact sensor located on the upper body, said contact sensor activated by a contact or force applied in a direction toward said base contact plane.

Preferably, said second orientation includes inclination of the base contact plane with respect to the work surface by at least 5 degrees.

According to a further aspect, said second orientation includes inclination of the base contact plane with respect to the work surface of between 1 and 50 degrees.

Accordingly to a further aspect of the present invention, said second orientation includes inclination of the base contact plane with respect to the work surface of between 7 and 30 degrees.

Preferably, said upper body includes a spine portion projecting upwards from the base.

According to a further aspect of the present invention, the upper body may include finger engaging surfaces on either side of the spine such that a user may grip the computer mouse by pinching the spine between a finger and thumb.

Preferably said mouse is configured to provide position data signals calculated using movement data of the pointing device as detected by the movement sensing system relative to a start position.

According to a further aspect, the first mode includes a pointing mode, and in said pointing mode said computer mouse is configured to generate said movement or position data signals indicating on-screen pointer movement or position respectively.

Preferably, said mouse is configured in said second mode to provide touch events to said computer.

Preferably, said mouse is configured to translate said movement or position data signals into corresponding movement and/or position touch events.

Preferably, said computer mouse provides said movement or position data signals to said computer and said computer is configured to translate said data signals into corresponding movement and/or position touch events.

According to a further aspect, the present invention includes a computer mouse configured to provide a touch event at a predetermined start position upon initiation of said second mode by said mode sensor, said computer mouse generating a position data signal corresponding to said start position.

Preferably, said computer mouse is configured to generate a corresponding touch event upon initiation of said second mode by said mode sensor.

Preferably, said mouse is configured to provide position data signals to the computer indicating a start position at a position representing an edge of a display screen connected to the computer, by two successive touch events.

Preferably, said mouse is configured such that any subsequent swipe gesture performed in said second mode after said successive touch events is provided as position and/or movement data signals indicating a touch event in a corresponding direction away from a given edge and wherein said given edge is inferred by said direction of said swipe gesture.

Preferably, the computer mouse is configured to provide a position data signal indicating a touch event at a restart position after a device movement interpreted as a swipe gesture, said swipe gesture being a movement of the pointing device from a start position in said second mode.

According to a further aspect, the start position is the position of an on-screen pointer when in said pointer mode before said second mode is initiated.

Preferably, the start position is a position corresponding to a centre, corner or edge position of a display screen connected to said computer.

Preferably, the computer mouse is configured to provide data signals to the computer when the mouse moves to a predetermined position, said data signals including a data signal corresponding to an end of a touch event, followed by a position data signal indicating a restart position for a subsequent touch event.

According to one aspect of the present invention, said predetermined position is within a threshold distance of an edge corresponding to an edge of a display screen connected to said computer.

Preferably, said mouse is configured to reposition an on-screen pointer or touch event to the start position after a swipe, flick, scroll or custom gesture.

A device capable of being connected to a computer, the device including:
at least one user input control for receiving user input to control the device;
at least one writeable memory storing device configuration data, the device configuration data being read by the device to determine operational characteristics of the device;
   characterized in that the device is capable of entering a configuration mode wherein the device is configured to:
send signals to the computer upon receiving user input to the at least one user input control, the signals corresponding to keyboard key-presses, sequences and/or combinations thereof; and
write data to said memory device to modify the device configuration data as a result of user manipulation of a said user input control.
   wherein the keyboard codes sent to the computer by the device are indicative of sequences and/or combinations of key-presses

A “computer mouse” is herein defined as a device used to provide input to a computer to indicate movement of the device and/or an on-screen Graphical User Interface (GUI) element, e.g. an icon, pointer or mouse cursor. Computer mice may be defined as a subset of a larger group of computer pointing devices including styluses, game controllers, trackballs, joysticks, remote controls, track-pads or the like.

A “computer” as referred to herein should be understood to include any computing device with a computer processor e.g. a desktop, laptop, netbook, tablet, phone, media player, network server, mainframe, navigation device, vehicle operating system or the like.

The computer mouse may have a computer interface unit provided in the form of a cord connection to the computer or a wireless chip to transmit signals via RF, Microwave, Bluetooth or other wireless protocols.

As used herein, a “work surface” is to be interpreted broadly and not in a restricted sense and includes but is not restricted to, a desk or table top, a surface of a computing device including the keyboard or screen, a person, or any other convenient surface. Similarly, the terms computer, host computer, or computing device and associated display, or the like are not limited to any specific implementation and include any desktop PC, portable computer, laptop, notebook, sub-notebook, PDA, palm device, mobile phone, wireless keyboard, touch screen, tablet PC, or any other communication and/or display device and any combination or permutation of same.

The term “spine” with reference to the computer mouse includes any upright structure or features capable of being grasped between a user's thumb and a finger to effect device movement, being narrower than the base portion and with at least one side of the spine projecting upwards from within the perimeter of the base portion, in contrast to a conventional mouse pointing device where the entire main body of the device extends upwards from the base perimeter.

“Fingertip engagement” as referred to herein with respect to thumb and fingertip engagement surfaces is used to denote a fingertip contact capable of moving and/or controlling the device and/or operating a contact sensor.

The term “contact sensor” as used herein refers to any sensor capable of detecting contact and/or pressure and includes by way of example depressible buttons as well as sensors capable of detecting changes in magnetism, conductivity, temperature, pressure, capacitance and/or resistance.

As used herein, the term touch event includes, but is not limited to, actual and virtual, simulated, emulated or translated touch actions on a touch screen or touch-enabled operating system capable of processing touch events and includes; a touch, tap, long-tap, swipe, flick, scroll, pan and zoom.

Reference herein will be made to a two-dimensional area provided with vertical and horizontal dimensions with respect to a display screen in a typical upright orientation. This reference is to aid clarity and understanding only and should not be seen to be limiting as it will be appreciated the display screen may be orientated in a horizontal plane. Similarly, reference herein may be made to the computer mouse moving in a ‘Y’ direction and an orthogonal ‘X’ axis respectively correlating to the vertical and horizontal dimensions on the display screen. It should be appreciated that the X, Y, horizontal and vertical references may be used interchangeably depending on the orientation of the display screen.

The base contact plane is formed from X and Y components representing orthogonal dimensions in the plane. In preferred embodiments, the pointing device may be slightly elongate and so may have a longitudinal and lateral dimension respectively corresponding to the Y and X dimensions.

In use in the first orientation the base contact plane is typically placed on the work surface and orientated substantially parallel thereto and in the second orientation the base contact plane is inclined between one and fifty degrees from the work surface. Thus, the second mode is only activated when the computer mouse is inclined such that the base contact plane is inclined between one and fifty degrees from the work surface.

The inclination is effected by a rotation of the base contact plane about a reorientation axis which may include components in both the X and Y dimensions with a majority of rotation occurring about a Y axis. It will be appreciated that the most comfortable rotation for a user holding the pointing device will be a left of the device a rolling of the wrist and a slight backwards tilt. This would result in mainly clockwise rotation for a right handed user and anticlockwise rotation for a left-handed user with backward tilt in both cases. The mouse may also be lifted to assist in the reorientation.

Hereinafter reference to the pointing device orientations will be made with respect to a longitudinal (Y), lateral (X) and vertical (Z) conventional coordinate system with a user's hand extending forward to the pointing device along the Y dimension and wrist rotation generally about the Y axis.

Preferably, the computer mouse includes a movement sensor system capable of detecting device movement relative to a work surface. The movement sensor system may also generating device movement information in the form of movement data signals capable of being read by the computer.

The movement sensor system may also generate device position information in the form of position data signals capable of being read by the computer. The position information may be generated by detecting movement relative to an initial reference or ‘start’ point and calculating the displacement from the start point.

The movement and position data signals may respectively indicate movement and position coordinates within a virtual two-dimensional reference area having at least three edges. The reference area can be used as a reference representing a computer display screen, touchpad or other potential input area of the computer.

The position data signals preferably indicate a relative position of the computer mouse as a proportion of the reference area, e.g. the position data signal may indicate a position as 56% vertical and 22% horizontal indicating a position at 56% of the display screen vertical dimension and 22% of the display screen horizontal position relative to reference screen edges. The computer mouse can thus be used with any screen resolution or size without further configuration or calibration as the movement and/or position is simply scaled to the screen size.

In a further embodiment the movement data signals include an indication of device movement speed relative to the work surface.

It will be appreciated that a conventional computer mouse may use an optical system comprising an image capture sensor or array that is positioned over an aperture open to a work surface illuminated by a light source such as an LED or Laser. A lens focuses the light from a focus zone of the surface to the image sensor and lens, which are orientated parallel to the work surface. The image capture sensor detects device movement by capturing successive images and comparing the images to determine relative movement. The movement information is transmitted to the computer and translated to mouse cursor movement on the display. However, a typical mouse optical system will not track movement when the mouse is lifted as the image sensor receives an image out of focus such that successive images cannot be compared accurately and movement therefore not detected. This deactivation when out of focus is an important function of a conventional mouse as the user needs to be able to lift and reposition a mouse to move a mouse cursor large distances, repeat scrolling/panning movements, re-position their hand for comfort without moving the cursor or otherwise manipulate the mouse without moving the cursor. Conventional mice will also not work if they are inclined away from the work surface as the optic sensor again loses focus and therefore must be operated parallel to and directly above the work surface at the lens focus point.

Thus, in one embodiment, said movement sensor system is an optical movement sensor system including:
a light source configured to illuminate the work surface, and
an image sensor, configured to receive reflected light from said work surface to capture an image of the work surface, wherein successive captured images are compared to determine device movement.

Preferably the optical movement sensor system is located and configured such that the image sensor captures images exceeding a threshold level of clarity, resolution, edge-contrast to other parameter such that the movement sensor system can detect differences between successive images indicating movement in both the first and second orientations.

The second orientation is typically at least five degrees inclined from said first orientation and may be any orientation between one and fifty degrees.

Preferably, the optical system is positioned such that the focal zone of the optical system is at or adjacent to the mode sensor.

Preferably, the optical system is configured with a depth of field sufficiently large such that substantially focused light from the work surface is received by the image sensor in both the first and second orientations and wherein said second orientation is at least five degrees inclined from said first orientation

It will be appreciated that the image sensor may have some tolerance in processing images and so may be able to process slightly unfocused images from the work surface. Thus, reference herein to substantially focused should be interpreted to mean focused within the tolerance limits of the image sensor used and need not be perfectly focused.

Preferably, said optical componentry includes at least one lens for focusing the light to the image sensor.

In one embodiment said image sensor is inclined with respect to the base contact plane and orientated to receive light reflected from the work surface in both said first and second orientations. In a further embodiment, the optical componentry includes at least one lens positioned between the image sensor and the light reflected from the work surface, the lens focusing and/or redirecting light to said image sensor from said work surface. Preferably, at least two lenses are provided and are inclined with respect to each other and with respect to the image sensor and to the contact plane. The multiple lenses thus allow a focused image to be directed to the image sensor even if the image sensor is not parallel to the work surface as the lenses redirect light to the image sensor in both the first and second orientations.

Preferably, the image sensor is inclined in the direction of reorientation to said second orientation and more preferably approximately tangentially to an arc about a reorientation axis. Thus as the pointing device rotates, the distance from the image sensor to work surface may vary on slightly and thus the work surface remains substantially in focus even in the second orientation.

Preferably, the optical componentry include at least one prism with an input face for receiving light from the work surface, an output face for directing light to the image sensor and a reflecting surface for reflecting light from said input face to said output face.

Preferably the input face is inclined from said base contact plane and more preferably inclined in the direction of reorientation to said second orientation.

In a further embodiment the input face is aligned approximately tangentially to an arc about a reorientation axis. Thus as the pointing device rotates, the input face remains tangential to the arc and therefore the approximate distance from the input face to the work surface remains similar and thus the work surface remains substantially in focus even in the second orientation.

The use of such a prism allows the image sensor to be located within the body of the pointing device and orientated in a convenient orientation with the prism acting to direct the light to the image sensor.

Preferably, said optical componentry includes a first prism and a second prism,
the first prism having:
   an input face for receiving light reflected off the work surface,
   an output face for transmitting light to the second prism,
   a reflecting surface for reflecting light from the input face to the output face,
the second prism having:
   an input face for receiving light from the first prism output face,
   an output face for transmitting light to the image sensor, and
   a reflecting surface orientated to reflect light toward the second prism output face.

Preferably, the first and second prisms are identical in shape and optical properties and are preferably constructed from a Polycarbonate material.

Preferably, the optical componentry includes a lens positioned between the first prism output face and the second prism input face.

In one embodiment at least one lens may be positioned on or adjacent the:
first prism input face;
first prism output face;
second prism input face;
second prism output face.

Preferably, an aperture is provided between the first prism output face and the second prism input face.

Preferably, the optical componentry also includes a light source orientated to irradiate light onto the work surface beneath the optical componentry and more preferably at the focal zone of the optical componentry.

The computer mouse is preferably rotated about the mode sensor when reoriented to activate the mode sensor which thereby acts as a pivot point. Thus to minimize potential distance variation of the receiving portion (where light reflected from the work surface is received, e.g. first prism input face) to the work surface, the receiving portion of the optical componentry is preferably located adjacent the mode sensor. Minimizing distance variation from the receiving portion to the work surface also minimizes the potential for the optical componentry to lose focus.

Preferably, the computer mouse includes a communication system capable of communicating contact sensor signals to a computer and associated display screen to provide input signals for software operating on said computer.

Preferably, the mode sensor protrudes downwards from the base toward the work surface.

Preferably, the mode sensor is located in a position such that re-orientation of the computer mouse to incline the base contact plane from the work surface activates said mode sensor by contact and/or proximity with said work surface.

Preferably, the mode sensor is located in a position such that re-orientation of the computer mouse from said first to said second orientation activates said mode sensor.

Preferably, the mode sensor is located on the base and does not lie within the base contact plane of said lower surface. In one embodiment, the mode sensor is located on the base at a position elevated from the contact plane with respect to the work surface when the computer mouse base contact plane is resting on the work surface.

The mode sensor may be a button-type switch such as mechanical type plunger, rubber dome with carbon contact, foam element, lever contact or similar depressible button type contact sensor. However, as the pointing device rests on the mode sensor when inclined in the second mode, the travel and tactile ‘click’ feedback of typical depressible buttons may be undesirable. Moreover, friction may wear the surface of the mode sensor during use. Thus, the mode sensor is preferably a hard-wearing depressible foam element button with a thin foam element to minimize travel of button to activate. In another embodiment the mode sensor is a pressure sensor or lever arm actuator.

The mode sensor preferably has an outer contact surface for contacting the work surface. The outer contact surface is preferably constructed from Teflon, Nylon or other hard-wearing, low-friction material.

In one embodiment, the mode sensor has an outer contact surface with a lower portion lying in the base contact plane, the mode sensor depressible when the computer mouse is reoriented to activate the second mode.

Preferably, the mode sensor is releasably connected to the computer mouse and/or preferably has a releasably connected outer contact surface.

It will be appreciated that in an alternative embodiment the modes may be swapped i.e. the second mode is operational when in the first orientation and the first mode operational when in the second orientation.

It will be appreciated that the reorientation may include translation as well as rotation and may include multiple movements or a three-dimensional path. However, to aid clarity, reference will be made to rotation about a reorientation axis about which the computer mouse is rotated between the first and second orientations. Reference to such a reorientation axis should not be deemed limiting to a singular axis or movement direction.

In one embodiment the computer mouse may include an orientation sensor and the second mode may be activated by inclining the base contact plane past a threshold inclination as detected by the orientation sensor. The orientation sensor may for example include a gyroscope.

Preferably, the computer mouse includes a communication system capable of communicating the movement sensor signals to a computer.

The communication system preferably includes a wireless communication system such as a Radio Frequency (RF) transceiver and more preferably includes an RF chip capable of supporting Bluetooth wireless standards.

The computer mouse is preferably configured to halt movement sensor signal generation when the image sensor detects an out of focus image. Thus, a user may lift to reposition the computer mouse without on-screen pointer movement or gesture GUI movements.

Preferably, when in said first and second modes, the computer mouse is configured to generate data signals for a computer indicating the computer mouse is operating in said first and second modes respectively.

Preferably, the first mode is a pointing mode, wherein the computer mouse generates movement data signals indicating movement of the computer mouse and results in on-screen pointer movement.

In one embodiment the second mode includes a gesture mode and the computer mouse is configured to generate movement data signals interpretable by a computer as swipe gestures. As referred to herein the term “swipe” refers to a type of user command for a computer resulting in movement of GUI elements such as GUI pages, icons, text, screens or windows. Example swipe movements include pan (vertical and/or horizontal movement), scroll (vertical movement) and flick (rapid vertical or horizontal movements). Thus, a relatively slow pointing device movement in the positive Y direction may be interpreted as an upward scroll.

The swipe gestures may also include custom gestures such as shapes, alphanumeric characters, symbols or patterns, thereby providing additional controls and potential commands.

The gesture mode is particularly useful in document and browser navigation or for use with touch-screen computers which are configured to receive gesture inputs from a user's finger e.g. in gesture mode the computer mouse may provide computer commands interpreted as finger swipe gestures without requiring a user to touch the screen.

In another embodiment, the second mode includes a drawing mode wherein the computer mouse is configured to generate movement data signals interpretable by a computer as movement of a computer software drawing element such as a digital pen, brush or the like. The drawing mode is particularly useful when manipulating Art, Drawing, Computer Aided Drafting (CAD) or similar software programs as a user may easily switch between the pointing and drawing modes using only the computer mouse and not requiring additional keyboard commands or on-screen GUI element selection.

The aforementioned embodiments thus provide an enhanced computer mouse that can conveniently and quickly shift between operating modes to offer additional functionality over a conventional computer mouse.

It will be appreciated that the computer may be required to have suitable software to correctly interpret the computer mouse signals. However, the computer mouse is preferably configured to generate data signals of a generic or widely utilized standard and for example in the first mode the computer mouse generates data signals matching conventional mouse movement data signals and in said second mode generates data signals matching fingertip or stylus contact signals.

Preferably, an on-screen trace is displayed when in said gesture mode, said trace matching the movement of the computer mouse.

The computer mouse preferably includes a computer memory chip for storing operating instructions and preferably includes a non-volatile memory chip to avoid the need for a continuous power supply to maintain memory state. The memory chip is preferably writable by connection to an internet user interface for programming the chip.

A common implementation of a swipe gesture involves movement of the finger over the touch-screen from one side to another, upwards or downwards resulting in a movement of the GUI objects, e.g. to flip through pages of an e-book, application or the pages on a home-screen. A finger is lifted and returned to the centre portion of the display to repeat the gesture for multiple pages. However, a conventional on-screen cursor does not emulate the finger-movement as the cursor must track back over the screen to reach the centre portion for multiple swipes. This action may be interpreted by the computer as a swipe in the reverse direction or requires software to ignore the reverse track.

Thus, in one preferred embodiment, the mouse is configured to provide a fingertip input at a predetermined start position when the mode sensor is activated. Preferably, the start position is the position of the on-screen pointer when in said pointer mode, before entering said gesture mode.

In alternative embodiments the start position may be a centre, corner or edge position or other predefined position.

Preferably, the mouse is configured to indicate a start position as an edge position by making two successive activations of the mode sensor within a predetermined time period. In a further embodiment, any subsequent swipe gesture is provided as movement of a finger from the start position such that a swipe in the left, right, up or down direction will be interpreted as a finger swipe inwards, respectively from the right, left, bottom or top screen edge. Thus, the mouse may be used to make screen-edge gestures by first double tapping the mode sensor.

According to another aspect of the present invention, there is provided a computer mouse as aforementioned and configured to reposition an on-screen pointer to a ‘start’ position after a swipe gesture when the computer mouse is in the gesture mode.

Preferably, the pointer is repositioned when the pointer reaches a predetermined portion of the screen. Preferably, said predetermined position is a position within a threshold distance of the edge of the screen and more preferably is within 10% or 5% distance of the screen edge.

In one embodiment, the computer mouse may be configured to reposition an on-screen pointer to the ‘start’ position after a swipe gesture travels a predetermined length and more preferably a predetermined proportion of the screen. In a further embodiment said predetermined proportion is at least 30% and more preferably at least 50%.

In a further embodiment the proportion or threshold distance may be device-dependent, application-specific or set by a user.

In one embodiment the computer mouse is configured to reposition an on-screen pointer tithe ‘start’ position after a flick, scroll or custom gesture.

The repositioning of the pointer is effected by the computer mouse detecting the swipe gesture, determining whether the pointer needs to be repositioned and sending a subsequent data signal indicating the ‘start’ position for the pointer to be displayed at.

Thus a user can operate the computer mouse in a more similar manner to using a finger or stylus than a conventional mouse as the on-screen pointer can be re-centred after a gesture without tracking back over the screen, registering as a reverse swipe or requiring the user to manoeuvre the computer mouse back to a start position.

In one embodiment the computer mouse is configured to deactivate and/or hide on-screen pointer movement when in the gesture mode, the on-screen pointer respectively remaining in a static position or no longer be displayed while the mouse remains in the gesture mode. Thus, a user may operate the computer mouse in the gesture mode without visible interference from the on-screen pointer/mouse cursor.

The lower surface preferably has a base contact plane formed from one or more portions or points of contact. The lower surface does not need to be a continuous planar surface and may instead include multiple projections, ridges or other protrusions having contact points forming a common base contact plane. The base contact plane may include surfaces, projections or combination of surfaces/projections capable of forming a contact plane for being placed in contact with a work surface to support the computer mouse in an ‘upright’ orientation.

The base and upper may be formed as one continuous component or formed from separate connectable components. The base is herein defined as the portions of the mouse forming the lower extents (with respect to a reference upright position) of the device.

Preferably, said upper body includes a spine portion projecting from the base.

In a further embodiment the upper body may include finger engaging surfaces on either side of the spine such that a user may grip the computer mouse by pinching the spine between a finger and thumb.

In a further embodiment the computer mouse includes:
a spine portion, projecting substantially upward from said base portion and having a thumb-engaging surface on a first lateral side of the spine,
at least one index fingertip and/or middle fingertip-engaging surface on a second lateral side of the spine opposing said first lateral side.

In a further embodiment the computer mouse includes a thumb-retaining portion, associated with said thumb-engaging surface and capable of retaining a user's thumb during use such that the device is capable of being moved by solely lateral movement of the thumb in a direction away from the spine,

Preferably, the upper body includes at least one contact sensor and more preferably includes at least two contact sensors.

Preferably, one contact sensor is aligned in front and below the other.

Preferably, both contact sensors are positioned on single fingertip-engaging surface on an upper portion of the spine. In a further embodiment the rear contact sensor protrudes from the spine to a greater extent than the front contact sensor.

According to one aspect of the present invention, there is provided a computer mouse configured for use with a touch-screen operated computer, said computer mouse including:
a base adapted for sliding over a work surface;
an upper body extending upward from the base;
at least one contact sensor on the upper body;
a movement sensor system for detecting device movement;
a communication system for transmitting data signals to the computer, said data signals indicating said detected device movement;
   wherein the computer mouse is configured to position a finger input point in a ‘start’ position after a device movement interpreted as a swipe gesture, said swipe gesture being a movement of the pointing device from a start position with said contact sensor activated.

Preferably, the contact sensor is a mode sensor protruding downwards form the base portion.

The device movement is preferably interpreted by the computer as a continuous fingertip or stylus movement over the touch-screen.

According to a first aspect of the present invention there is provided a device capable of being connected to a computer via a wired and/or wireless connection, the device including:
at least one user input control for receiving user input to control the device;
at least one writeable memory storing device configuration data, the device configuration data being read by the device to determine operational characteristics of the device;
   characterized in that the device is capable of entering a configuration mode wherein the device is configured to:
send signals to the computer upon receiving user input to the at least one user input control, the signals corresponding to keyboard key-presses, sequences and/or combinations thereof; and
write data to said memory device to modify the device configuration data.

According to a second aspect, there is provided a method of configuring the aforementioned device using a computer, the method including:
manipulating a said user input control to cause the device to enter the configuration mode;
opening a web browser on said computer and navigating to a network address corresponding to a configuration webpage for the device;
manipulating a said user input control to alter the device configuration data, the web browser displaying a visual indication of the change to the device configuration data caused by the user input control manipulation.

According to a third aspect, there is provided a computer server configured to serve a configuration webpage for the device, the server configured to change Graphical User Elements (GUI) on said webpage in response to receiving keyboard key-presses, sequences and/or combinations thereof from the computer thereby providing a visual indication of the change to the device configuration data caused by the user input control manipulation

Preferably, the at least one user input control includes a button or contact sensor. Other user input controls may include switches, capacitive sensors, touch-screens, joysticks, trackballs, optical sensors, photoelectric sensors or any control mechanism capable of being manipulated by a user to provide user input.

Preferably, the memory is a non-volatile memory such as Flash memory, F-RAM or MRAM.

Preferably, the device is a computer mouse, such as a computer mouse, and includes multiple user input controls, including at least two buttons and an optical movement sensor. Preferably, the computer mouse includes a scroll wheel.

Preferably, the keyboard codes sent to the computer by the device are indicative of combinations of key-presses and more preferably indicate at least three simultaneous key-presses. Sending combinations of key-presses minimises the chance of the user input being interpreted by the computer as commands for other software applications. Thus, only the webpage will be capable of interpreting the key-press combinations.

Alternatively, the keyboard codes sent to the computer by the device are indicative of sequences of key-presses and more preferably indicate a sequence of at least three key-presses.

The aforementioned device in the configuration mode sends keyboard codes to the computer and these codes are interpreted by the webpage as inputs, e.g. a user may press a device button which transmits a unique keyboard code indicating a combination or sequence of keys pressed (e.g. AABB).

The webpage receives the keyboard code input and interprets it to indicate the user has issued a selection command to select a device parameter change. The device also changes that same parameter as a result of that button press.

The aforementioned device thus avoids the need for special driver software or user interface as the vast majority of computers are already configured to operate with a keyboard and are capable of receiving standardised keyboard signal codes.

To avoid prolixity, reference herein is made to the device being a computer mouse, such as a computer mouse though this should not be seen to be limiting as any device that has user input controls, (e.g. buttons) may utilise the aforementioned configuration. Such devices for example may include web cameras, televisions, fridges, microwave ovens, other appliances, vehicle control systems, speaker systems, calculators, printers.

### BRIEF DESCRIPTION OF DRAWINGS

Further aspects of the present invention will become apparent from the following description which is given by way of example only and with reference to the accompanying drawings in which:

FIG. 1 shows a computer mouse according to one embodiment of the present invention and a host computer;

FIG. 2a shows a rear elevation of the computer mouse of FIG. 1;

FIG. 2b shows a rear elevation of the computer mouse of FIG. 1 inclined to operate in a second mode;

FIG. 3a shows a partial section view of the computer mouse of FIGS. 1-2b;

FIG. 3b shows a partial section of the computer mouse of FIG. 3a inclined to operate in the second mode;

FIG. 4 is a schematic diagram of the optical system of the computer mouse of FIGS. 1-3;

FIG. 5 is a schematic diagram of an alternative optical system of the computer mouse of FIGS. 1-3;

FIG. 6 shows the underside of a computer mouse according to one preferred embodiment of the present invention;

FIG. 7 is a transverse cross-section of the computer mouse of FIG. 6;

FIG. 8 is an isometric view of the computer mouse of FIGS. 6 and 7;

FIG. 9 is a cross-section through an optical sensor system of the computer mouse of FIGS. 6-8;

FIG. 10 shows a front elevation of the computer mouse of FIGS. 6-9;

FIG. 11a shows an enlarged view of a portion of the computer mouse of FIGS. 6-10;

FIG. 11b shows the enlarged view of FIG. 11a with the computer mouse titled to operate in the second ‘gesture’ mode;

FIG. 12 shows a perspective view of a computer mouse according to a second embodiment of the present invention;

FIG. 13 shows a front elevation of the computer mouse of FIG. 12;

FIG. 14 shows another perspective view of the computer mouse of FIGS. 12 and 13;

FIG. 15 shows a side elevation of a computer mouse according to a third embodiment of the present invention;

FIG. 16 shows a rear elevation of the computer mouse of FIG. 15;

FIG. 17 shows a computer display screen with a multi-page document being horizontally scrolled;

FIG. 18 shows a computer display screen with a right hand side menu displayed, and

FIG. 19 shows a webpage displaying configuration options for a computer mouse.

### BEST MODES FOR CARRYING OUT THE INVENTION

### REFERENCE NUMERALS FOR THE FIGURES

| | |
|---|---|
| 1 | Mouse |
| 2 | Computer |
| 3 | Base |
| 4 | Lower surface |
| 5 | Work surface |
| 6 | Feet |
| 7 | Base contact plane |
| 8 | Upper body |
| 9 | Spine |
| 10 | Thumb-engaging surface |
| 11 | Finger-engaging surface |
| 12 | Scroll wheel |
| 13 | Index fingertip engaging surface |
| 14 | Front ‘left’ button |
| 15 | Rear ‘right’ button |
| 16 | Image sensor |
| 17 | Optical system |
| 18 | Mode sensor |
| 19 | Stop |
| 20 | Indicator LEDs |
| 21 | PCB |
| 22a | First prism |
| 22b | Second prism |
| 23a | First prism input face |
| 23b | Second prism input face |
| 24a | First prism output face |
| 24b | Second prism output face |
| 25a | First prism reflecting surface |
| 25b | Second prism reflecting surface |
| 26 | Lens |
| 27 | Lens aperture |
| 29 | Three-state slider switch |
| 30 | Magnetic dock |
| 31 | Charging dock connections |
| 32 | USB receiver |
| 33 | Indicator LED |
| 34 | Display screen |
| 35 | Optics light source |
| 36 | Mode sensor lever |
| 38 | Focus distance - maximum second orientation |
| 39 | Focus distance - nominal second orientation |
| 40 | Source light directing prism |
| 41 | Mode sensor elevation |
| 42 | Inclined edge |
| 43 | Document |
| 44 | Start position |
| 45 | End edge position |
| 46 | Start edge position |
| 47 | End screen position |
| 48 | GUI settings bar |
| 49 | Brightness |
| 50 | Cancel |
| 51 | Webpage |
| 52 | Configure instructions |
| 53 | Menu |
| 54 | Feedback textbox |
| 100 | Mouse - second embodiment |
| 101 | Base |
| 102 | Upper body |
| 103 | Left mouse button |
| 104 | Right mouse button |
| 105 | Scroll wheel |
| 106 | Lower surface |
| 107 | Base contact plane |
| 108 | Base supporting feet |
| 109 | Mode sensor |
| 110 | Optical system |
| 111 | Inclined side edge |
| 112 | Inclined front edge |
| 200 | Mouse - third embodiment |
| 201 | Base |
| 202 | Upper body |
| 203 | Left mouse button |
| 204 | Right mouse button |
| 205 | Scroll wheel |
| 206 | Lower surface |
| 207 | Base contact plane |
| 208 | Base supporting feet |
| 209 | Mode sensor |
| 210 | Optical system |
| 211 | Inclined side edge |
| 212 | Inclined front edge |

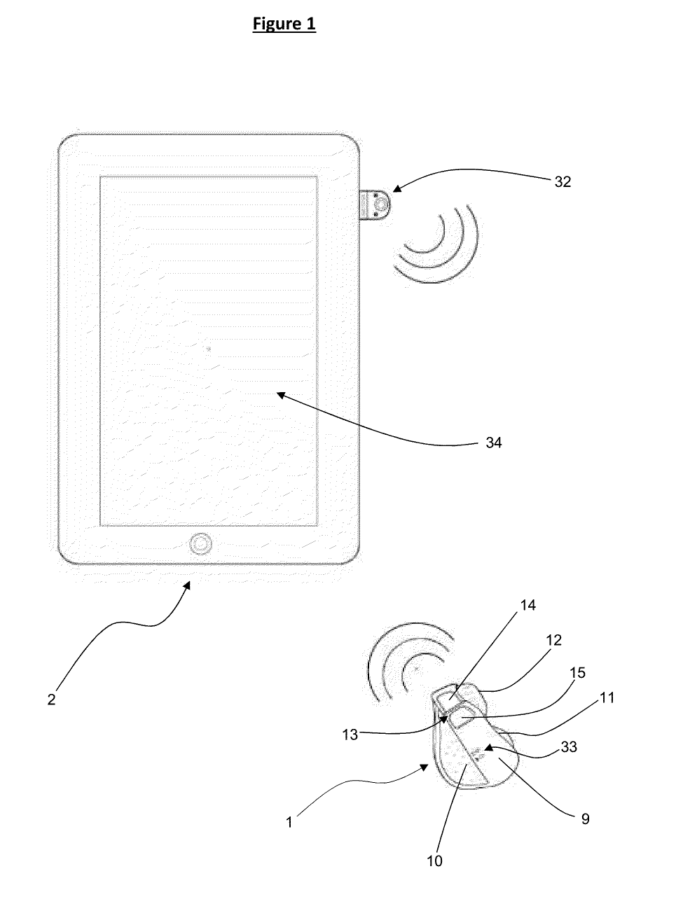

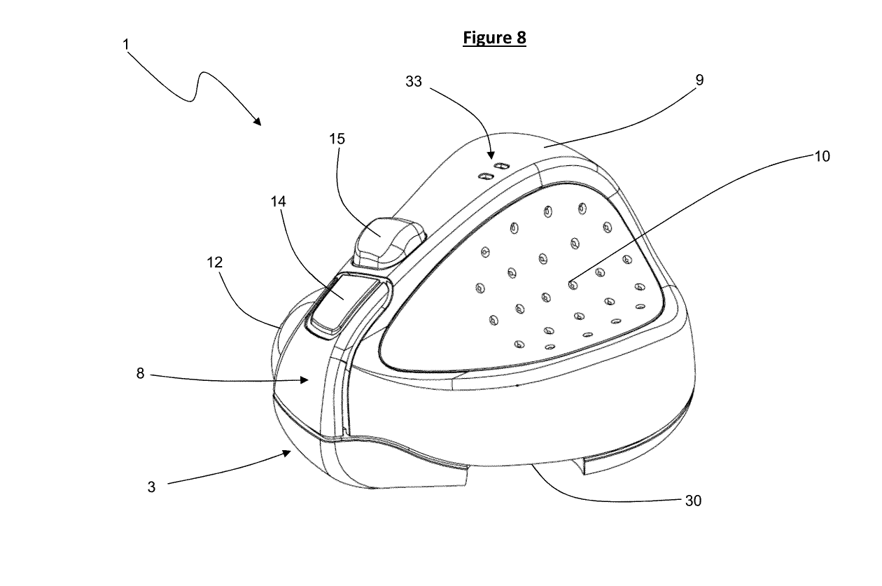

FIGS. 1-11b show a computer mouse (1) according to one preferred embodiment of the present invention. The mouse (1) is connectable to a computer, shown in FIG. 1 as a tablet computer (2) with a touch-screen (34).

Preferred embodiments of the present invention are particularly suited to touch-screen computers such as tablets, smartphones or computers with touch-input capable operating systems. However, it should be appreciated the present invention may have useful applications for use with desktops, laptops, notebook computers, televisions, games consoles, navigation systems, augmented reality systems or indeed any computer.

The mouse (1) has a body including a lower base (3) portion with a lower surface (4) configured for sliding across a work surface (5), e.g. a desk, table, book, laptop palm-rest or other surface. The lower surface (4) has a plurality of supporting projections (6) (hereinafter “feet”) with lowermost portions contacting the work surface (5) collectively forming a base contact plane (7). The feet (6) are provided to support the mouse (1) in a stable orientation while minimising friction as the mouse moves over the work surface (5). The feet (6) are thus shaped, sized and arranged accordingly to balance these two functions.

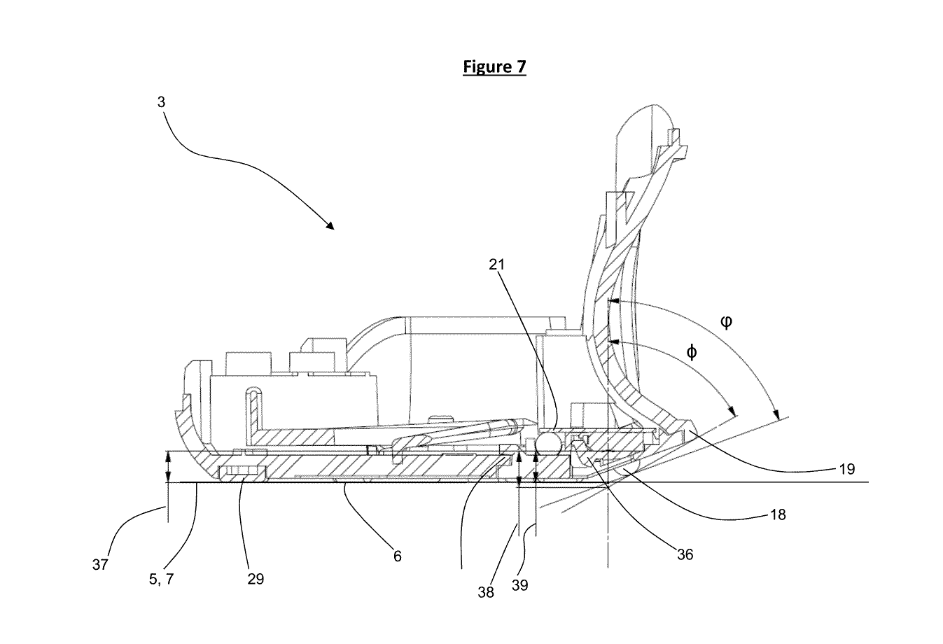

The mouse (1) in these embodiments is elongate along a longitudinal axis (Y) with respect to an orthogonal lateral axis (X) as shown in FIG. 6.

An upper body (8) extends upwards from the base (3) and has a spine (9) with a thumb-engaging surface (10) on one lateral side of the spine (9) and a finger-engaging surface (11) on the opposite lateral side. The finger-engaging surface (11) is shaped and positioned to allow the user to place a middle, ring and/or little finger on it with the thumb on the opposite side of the spine (9), the mouse (1) thus being held in a pinch-grip akin to a pen-grip. At least the index finger is thus free to manipulate buttons (14, 15) and scroll wheel (12). The spine (9) thus has an index fingertip-engaging surface (13) on top of the spine (9).

A scroll-wheel (12) is provided on the forward portion of the mouse (1) and is elevated from the base contact plane (7) to prevent wheel rotation during planar mouse movement. The scroll-wheel (12) may be used either by the user rolling a finger over the scroll-wheel (12) or by tilting the mouse (1) forward and to the right (for a right-handed mouse) so that the scroll-wheel (12) makes contact with the work surface (5). The scroll wheel (12) rotates due to frictional contact with the work surface (5) as the user moves the scroll wheel (12) over the surface (5). The scroll-wheel (12) is also frustoconical so that when tilted the circumferential outer surface is roughly parallel with the work surface (5) thereby maximizing contact surface area and friction.

To aid clarity, we herein define the base (3) as being the portion of the mouse (1) below the finger-engaging surfaces (10 and 11) and button (14). The base (3) thus demarcated from the upper body (8) by a mutual boundary extending about the lateral periphery of the mouse (1) at the lower edges of the finger-engaging surfaces (10, 11). The finger-engaging surfaces (10 and 11) are thus defined as part of the upper body (8). The buttons (14, 15) are also positioned on the upper body while the scroll wheel (12) extends over both the base (3) and upper body (8) but is typically mounted with the rotation axis through the upper body (8). It will be appreciated that the mouse base (3) and upper body (8) may be formed as separate joinable components, formed as a unitary body or formed from multiple components. Reference herein is made to separate components for clarity, though this should not be seen as limiting.

The mouse (1) has an internal battery capable of being charged through a dedicated charger or the USB receiver (32) which couples with a magnetic dock (30) and two electrical contacts (31) on the base (3) of the mouse. The mouse (1) is also configured to automatically pair with a particular computer USB receiver (32) when it is docked with that USB receiver (32) thus enabling different mice to be used with different USB receivers than the receiver paired with a mouse at manufacture.

An indicator LED (33) is positioned on the top of the spine (9) and is used for various indications, e.g. battery state and ON-CONFIGURATION states or other indications.

The embodiment illustrated in FIGS. 1-11b shows a mouse (1) optimised for use by a right-handed user though it will be appreciated a mouse may be created for left-handed use by creating a mirror image of the mouse (1).

Contact sensors are provided in the form of front (14) and rear (15) depressible buttons located on the upper portion of the spine (9) forming the index fingertip-engaging surface (13). The front button (14) is configured to perform ‘left’ click actions and is positioned forward and below the rear button (15) which is configured for ‘right’ click actions. The provision of the front (14) and rear (15) buttons on a single finger-engaging surface minimizes the space required and thus allows a smaller mouse to be created with the same functionality as a larger mouse with laterally arranged buttons. However, as a finger curls to click a rear button, the fingertip naturally raises and so if the buttons were at the same level the rear button would require an uncomfortable movement to operate. The rear button (15) is thus raised and rearward so that a user can comfortably operate both the front (14) and rear (15) buttons with different parts of the same finger, typically the index finger.

The mouse (1) is a small, highly maneuverable mouse measuring less than approximately 6 cm long by 4 cm wide by 3.5 cm high. The spine (9) is less than 2 cm wide at its widest point and tapers to a narrow portion of less than approximately 1.5 cm. Such a small mouse (1) enables the user to easily grip the spine (9) between thumb and middle finger (or ring finger) in a pen-grip style enabling the index finger to operate both buttons (14, 15).

The embodiments illustrated in FIGS. 1-11b further include a movement sensor system provided in the form of an optical movement sensor system (17) capable of detecting relative movement between the mouse (1) and work surface (5).

The optical movement sensor system (17) includes a light source (35) configured to illuminate the work surface (5) and an image sensor (16) configured to receive reflected light from the work surface (5) to capture an image of the work surface (5). An image processing chip compares successive captured images to determine the direction and degree of device movement. The image sensor (16) may be of a known type such as an active pixel sensor imager CMOS type. Such optical sensors (16) are known for use with computer mice and are typically used in conjunction with an LED or laser light source (35) that illuminates the supporting surface sufficiently for optical detection of mouse movement. The LED, laser or other light source (35) is located in the base (3) and the light therefrom is directed to illuminate the area below the optical system (17).

The relative movement over a support surface as detected by the optical movement sensor system (16) may be used to generate movement data signals to be passed to the computer (2) to instruct the computer to display movement of an on-screen GUI element such as an on-screen mouse pointer. Typically prior art mice provide the computer with movement data signals provided as a vector, e.g. direction 4x, 5y at speed v. However, the optical movement sensor system (16) of the mouse (1) is configured to use the movement data and a known ‘start’ location to determine a coordinate location in a predefined two-dimensional area representing the bounds of a corresponding display screen. The coordinates for example are given as X and Y coordinates corresponding to a position relative to the edges of the 2D area. These coordinates are given as a percentage rather than an absolute coordinate (e.g. pixel coordinate) so that the mouse can be used with any size screen or resolution. A centre position is thus given as X50%, Y50% while an upper-left corner position may be X10% Y90%. The use of position data rather than just movement data can be used to provide enhanced functionality when used with touch-input operating systems and will be discussed more fully below.

The movement data signals, position data signals, contact sensor signals and scroll-wheel data signals generated by the mouse may be transmitted to the host computer (2) by a communication system using any convenient electrical transmission means and in preferred embodiments includes a wireless Radio Frequency (RF) chip capable of supporting both Bluetooth™ and USB wireless standards. The use of both Bluetooth and USB wireless protocols allows the mouse (1) to be used with computers only having Bluetooth capability as well as those without Bluetooth capability but capable of accepting a USB receiver (32). The USB receiver (32) is preferably a micro-USB receiver for improved compatibility with mobile devices which increasingly use micro-USB as a standard interface, though of course any suitable connector may be used. The mouse (1) includes internal control circuitry including a Printed Circuit Board (PCB) and a non-volatile memory (not shown). The memory stores configuration data relating to first and second operational modes and any other component configurations, e.g. for the buttons, scroll-wheel, image sensor, communication protocols, indicator LEDs (20) and the like.

The mouse (1) of the present invention provides enhanced functionality over prior art mice by being capable of operating in two different modes.

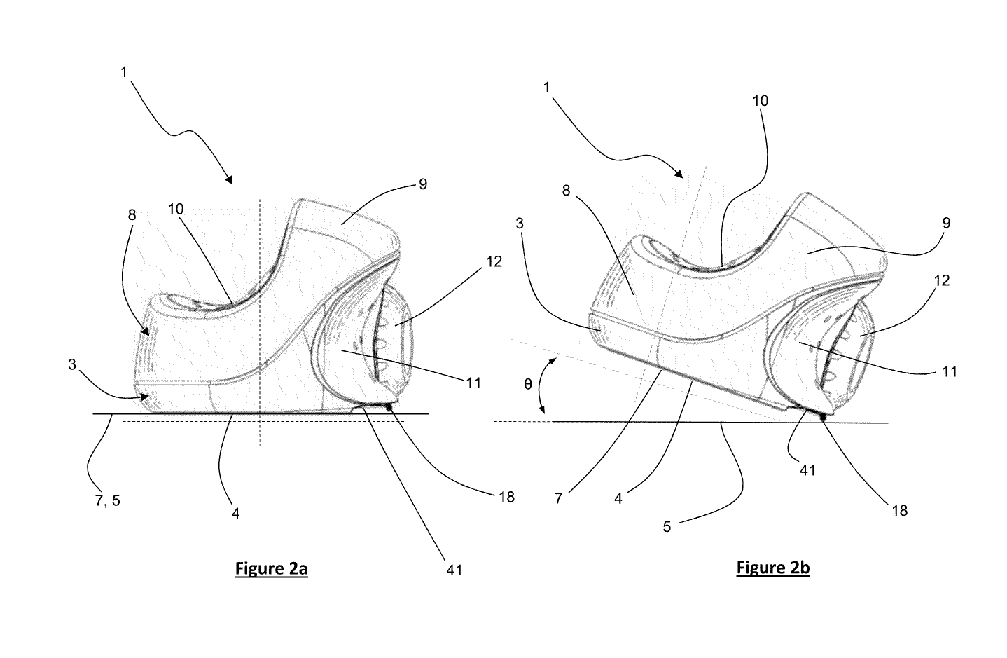

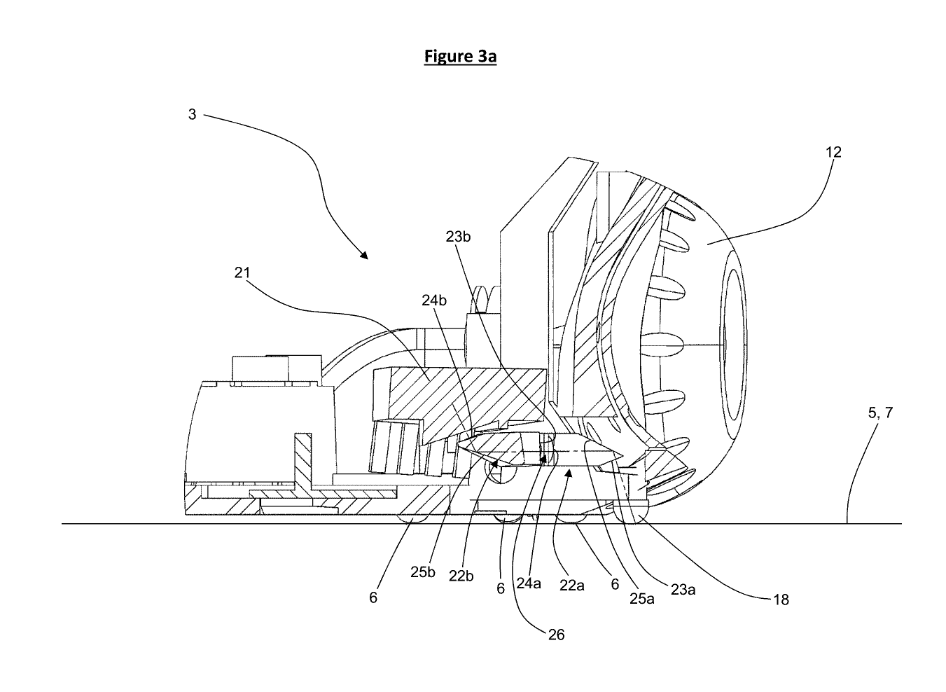

The mouse (1) is configured to operate in a first “pointer” mode when in a first orientation (see FIGS. 2a, 3a, 7, 10, 11a) with the base contact plane (7) in contact with the work surface (5) and can be pivoted (and optionally lifted) to a second orientation (see FIGS. 2b, 3b, 11b) with the base contact plane (7) inclined relative to the work surface (5).

A mode sensor (18) is provided in the base (3) and has a projection extending toward the base contact plane (7).

Reference herein is made to contact sensors and movement sensor systems being “activated” and “deactivated” to refer to the state of a button or the like being actuated or turned on (activated) and then released to return to it's original state (deactivated). It should be understood that this reference is to describe two alternative states or functions of the component and “deactivation” should not be interpreted as a complete exemplary only and each to refer to two states, e.g. on and off or input 0 or 1.

The mode sensor (18) is a switch capable of being in two states, e.g. first mode and second mode

activated due to contact and/or increased pressure from the work surface (5) which thereby and activates the second mouse operation mode or gesture mode.

It will be appreciated that users may manipulate the mouse (1) differently according to their preferences. Typically the reorientation is effected by lifting and tilting the mouse (1) until the mode sensor (18) contacts with the work surface (5). This movement is caused by finger and/or wrist manipulation to rotate and tilt the mouse (1) slightly backwards. This movement results in a predominantly clockwise rotation of the mouse (1) for a right handed user and anticlockwise rotation for a left-handed user, with backward tilt and potential lift in both cases.

Once in the second mode the mouse may be tilted about the mode sensor (18) in any direction with the mode sensor (18) acting as a pivot point.

The mode sensor (18) is positioned to prevent switching to the gesture mode until the mouse (1) is inclined past a threshold angle. Ideally, the threshold angle is a minimal inclination allowing the user to easily activate the gesture mode without excessive mouse manipulation. However, if the threshold angle is too small it may be too easy for the mode sensor (18) to be inadvertently contacted during mouse movement in the pointer mode thereby inadvertently switching to the gesture mode. Thus, a compromise must be made to minimise the threshold angle while minimising the risk of inadvertent switching between modes.

The threshold angle in preferred embodiments is an inclination of the base contact plane (7) from the work surface (5) of between five and ten degrees. In the embodiments shown in FIGS. 1-5 the gesture mode threshold angle is five degrees and in FIGS. 6-12 is seven degrees.

Reference is made herein to the second orientation in the singular though it will be appreciated the second orientation can be any orientation within a particular range. Reference to the “second orientation” should thus be understood to refer to any orientation within a “second orientation range”. The gesture mode reorientation range is defined as the angular three-dimensional range between the gesture mode threshold angle and a maximum angle where either:
a) the movement sensor system can no longer detect relative movement between the mouse (1) and work surface (5), or
b) the mouse (1) cannot be rotated further, e.g. if work surface (5) contacts a portion of the mouse (1) or the user is physically incapable of rotating further.

The gesture mode reorientation range is typically between five degrees and fifty degrees inclination from the work surface (5) as shown in the embodiment of FIGS. 1-5 or between approximately seven to thirty degrees in the embodiment shown in FIGS. 6-12.

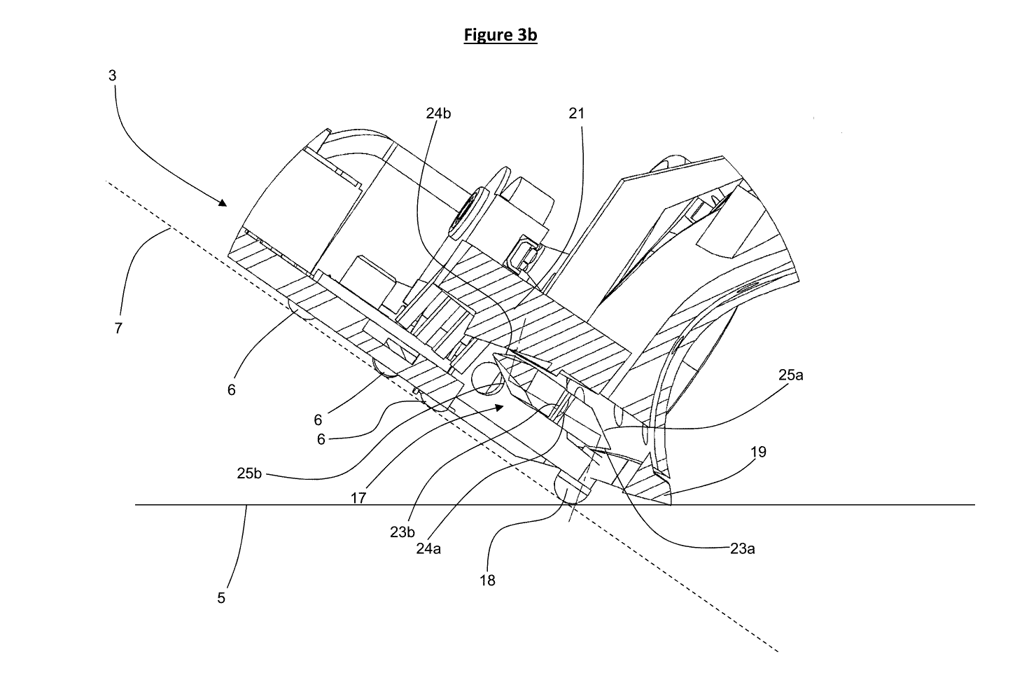

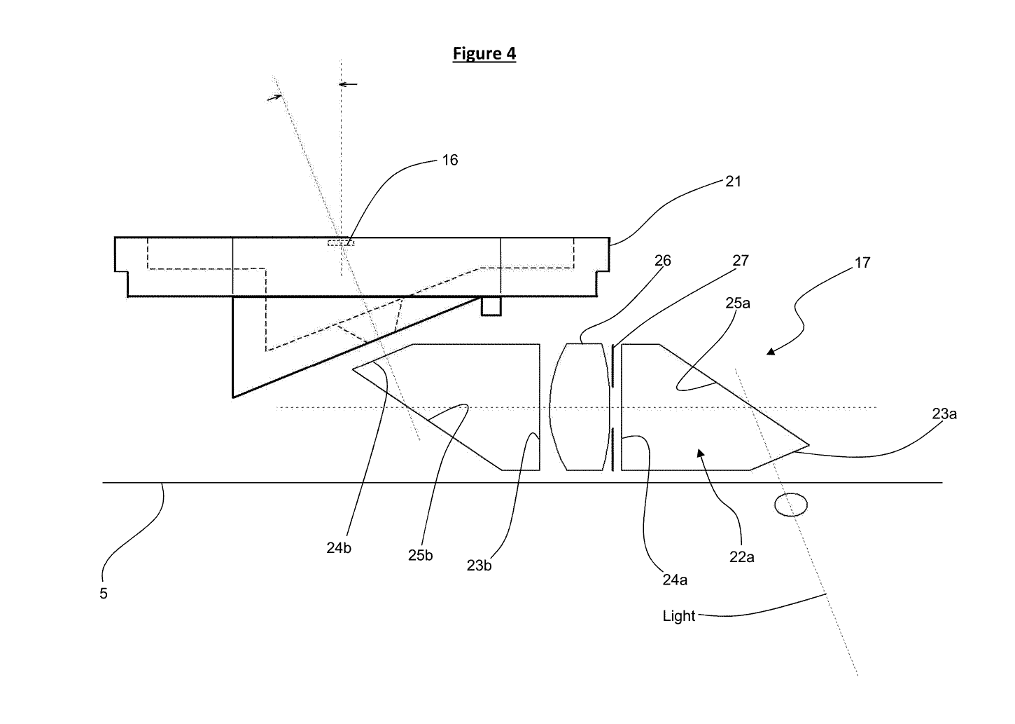

With respect to FIGS. 3a and 3b the angle of inclination in the second orientation may be up to thirty-five degrees at which point a stop (19) contacts the work surface (5) preventing further rotation. In an alternative embodiment (see FIGS. 2 and 2b) the stop (19) may be positioned to allow a fifty degree inclination before contacting with the work surface (5). It will be appreciated that while the stop (19) may provide useful tactile feedback indicating an inclination limit it is not necessary and the mouse (1) may alternatively be shaped to allow further free rotation.

FIG. 7 shows an embodiment with a nominal or optimum inclination (φ) measured from vertical as seventy degrees, i.e. a base contact plane inclination of twenty degrees from the work surface. The maximum inclination (φ) before contacting stop (19) is sixty one degrees i.e. a base contact plane inclination of twenty-nine degrees from the work surface.

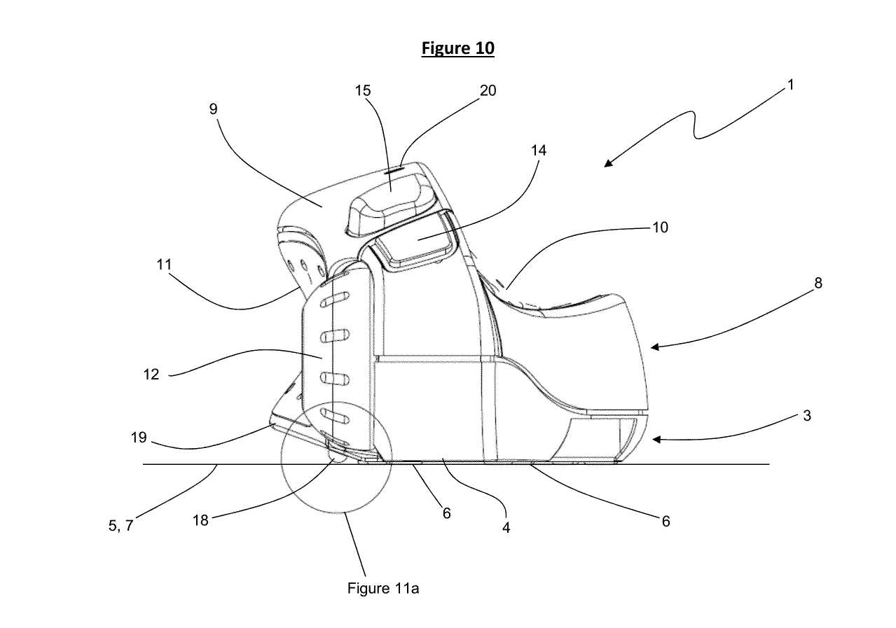

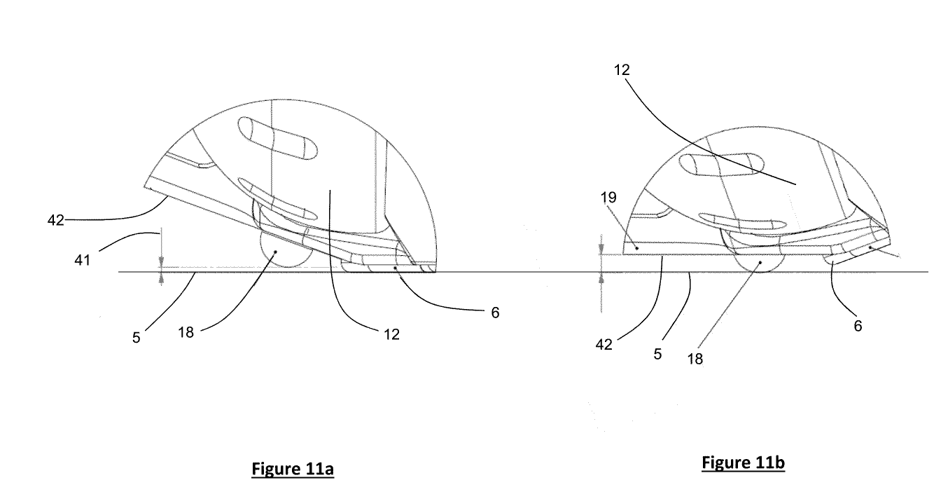

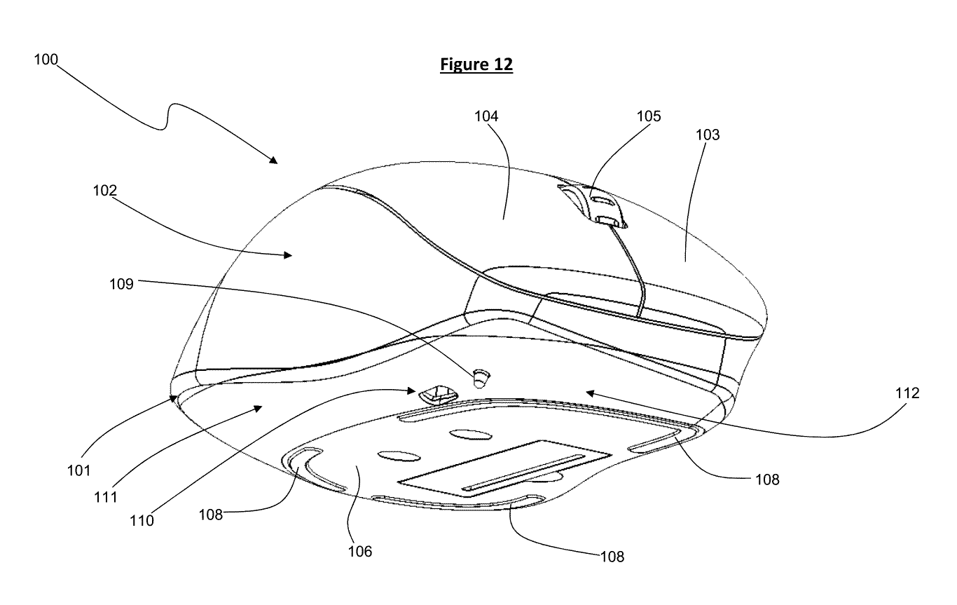

FIGS. 2a, 2b and 6-16 show the mode sensor (18) protruding from a portion (41) of the base (3) that is elevated from the base contact plane (7) in the first orientation (FIGS. 2a, 7, 10, 11a) and is activated by tilting and optionally lifting the mouse (1) into the second orientation (FIGS. 2b, 11b) to depress the mode sensor (18) and activate the gesture mode.

The mode sensor (18) protrudes downwardly from the base (3) to such an extent that when the mouse (1) is reoriented past a threshold angle the mode sensor (18) becomes the only point of contact with the work surface (5). The mode sensor (18) can thus be used as a small point of contact with the work surface (18) enabling very precise control by the user, akin to a pen nib.

The mode sensor (18) is formed as a depressible switch with an outer contact surface of Teflon® or other hard-wearing low-friction material for contacting and moving across the work surface (5). The mode sensor (18) is connected to an end of an internal lever (36) with a distal end configured to activate a switch or close a circuit on the circuit board inside the mouse (1, 100, 200).

The mode sensor (18) has a very small travel for activation relative to conventional buttons so that it is activated easily and doesn't produce an audible or tactile ‘click’ of a conventional button. Such a ‘click’ is ergonomically undesirable when moving the mouse (1) over the work surface (5) with the mode sensor (18) being the only point of contact as the user may apply uneven levels of pressure resulting in successive ‘clicks’. It is important that the mode sensor (18) is easily activated with minimal pressure so that it can slide easily over the work surface (5) without requiring the user push the mouse downwards which may result in significant strain on the user's hand.

The mode sensor (18) is also releasably connected to the lever (36) via a screw fitting to facilitate replacement of the mode sensor (18) if the outer contact surface wears. It is also envisaged the contact end of the mode sensor (18) could alternatively be releasably attached via a snap-fit enabling replacement.

Optical movement sensor systems (17) for use in the mouse (1) are shown more clearly in FIGS. 4, 5 and 9. Each optical movement sensor system (17) must be configured so that the image sensor receives images capable of being used to detect relative movement between the mouse (1) and work surface (5) in both the first and second orientations. This enables the mouse (1) to provide movement and/or position data to the computer in both the pointer mode and gesture mode.

It is envisaged that two separate sensors may alternatively be used, each detecting movement in only one of the modes and the mode sensor (18) being used to switch the appropriate sensor on/off. However, using multiple sensors introduces attendant cost increases, complexity and potential for failure. Moreover, each sensor used to detect movement in one mode needs to be deactivated in the other mode to prevent battery drain and any interference with the other sensor.

An example of an optical movement sensor system (17) is shown in FIG. 4 and includes two identical polycarbonate prisms (22a, 22b), with a lens (26) and aperture stop (27) therebetween. The first prism (22a) has an input face (23a) for receiving light from the work surface (5), an output face (24a) and a reflecting surface (25a). The light from the reflecting face (25a) then passes to the output face (24a). The second prism (22b) also has an input face (23b), output face (24b) and total internal reflecting surface (25b). The lens (26) and associated aperture (27) are positioned between the first prism output face (24a) and the second prism input face (23b). The image sensor (16) is mounted on the PCB (21) and receives light from the output face (24b). The first prism input face (23a) is inclined from the base contact plane by approximately 22 degrees and the reflecting surface (25a) is inclined at 55 degrees to the input face (23a) to ensure total internal reflection and direct the light to the lens (26). The double-prism optic system thus ensures that the light reflected from the work surface (5) is received by the image sensor (16) in focus in both the first and second orientations. It is important for the image sensor (16) to receive focused light reflected from the work surface (5) in both the first and second orientations so that the relative movement of the mouse (1) over the work surface (5) can be determined in both the first and second modes.

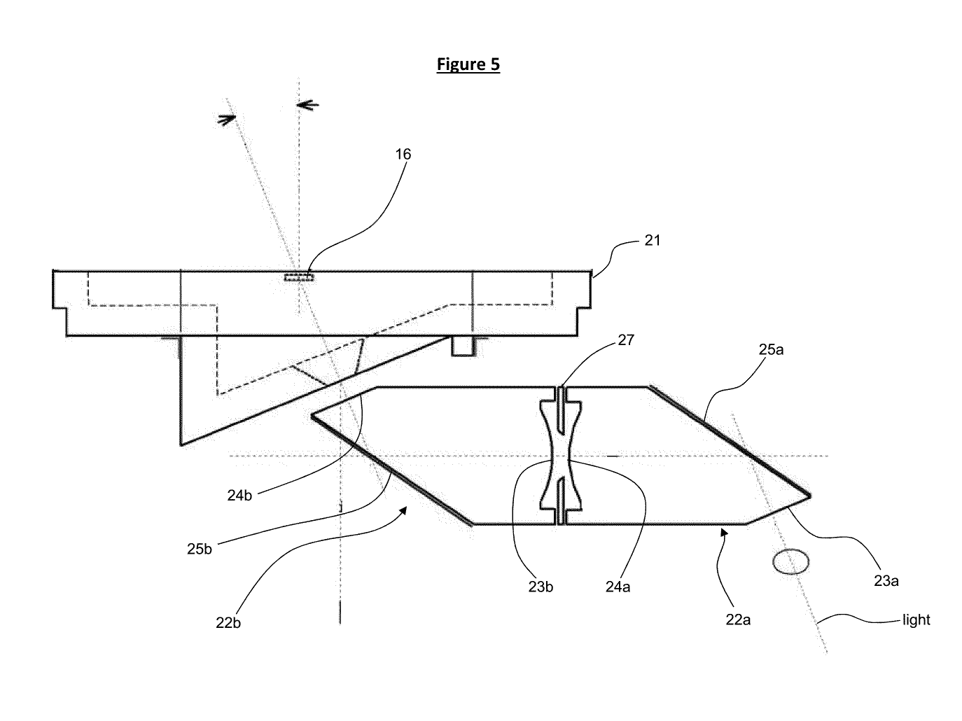

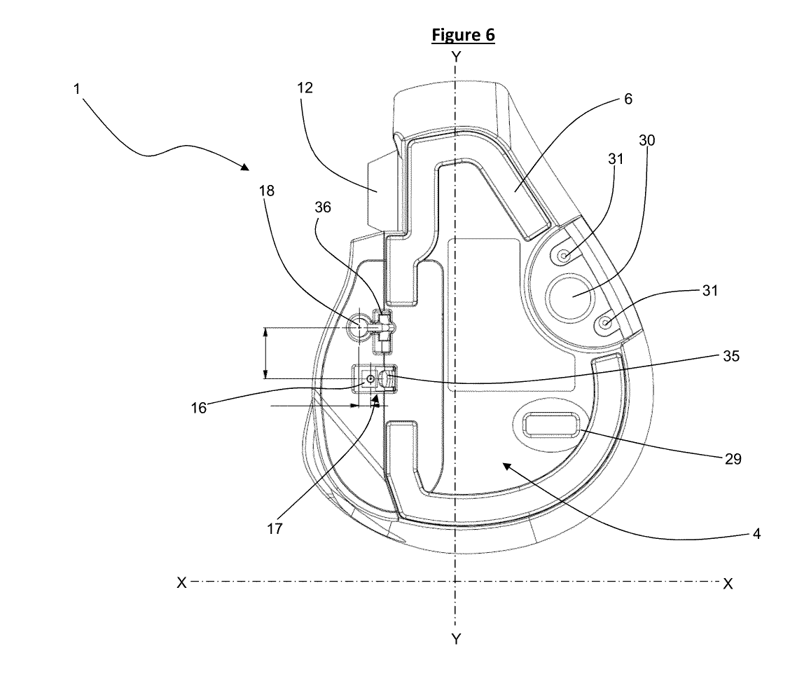

An alternative embodiment is shown in FIG. 5 and is generally similar to the arrangement of FIG. 4 but with the lens (27) formed on the first prism output face (24a) and second prism input face (23b).

The embodiments shown in the drawings are exemplary arrangements for the optical movement sensor system (17) and alternative optical systems for use in the mouse (1) are possible, including lens arrangements with at least one lens (26) inclined from the base contact plane (7) and/or the image sensor (16) itself may be inclined, e.g. being mounted on an inclined PCB. In one example, the optical system may have two prisms and lens components formed as a unitary body. The optical system (17) may thus take any form as long as it directs substantially focused light onto the image sensor (16) in both the first and second orientations.

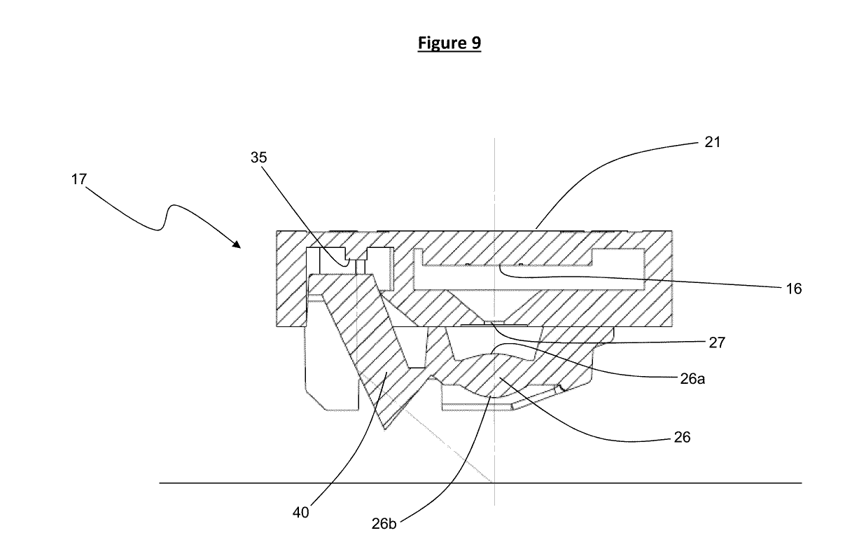

A preferred optical movement sensor system (17) is shown in FIG. 9 and instead of using inclined surfaces the optical system (17) is optimised to provide a sufficiently large depth of field enabling the mouse (1) to detect relative movement between the mouse (1) and work surface (5) in both the first and second orientations.

The optical system includes a light source (35) passing light to a prism (40) which redirects the light to a focal zone beneath a receiving lens (26), aperture (27) and optical sensor (16). The optical sensor (16) and light source (35) are mounted directly to the circuit board (21) which extends in a plane parallel with the base contact plane (7) with the light source (35) emitting light perpendicularly to the circuit board (21). The prism (40) is thus required to reorientate the light to illuminate the region below the lens (26b).

In this embodiment the depth of field is 0.88 mm+/−20% with minimum focal distance from the lower lens surface (26b) to the work surface (5) of 1.46 mm+/−10% and maximum at 2.34 mm+/−10% with an optimal focal distance at 1.78 mm between lower lens surface (26b) and work surface (5). It should be appreciated that these are exemplary dimensions and the optical system (17) may be modified to suit different sized and shaped mice as long as the optical sensor (16) receives images in both the first and second orientations sufficiently focused to detect relative changes and thus mouse movement.

The depth of field is determined by various system parameters, including lens aperture diameter, magnification, focal distance, distances between lens, aperture and sensor, sensor size/resolution and tolerances. The lens (26) shown in FIG. 9 is asymmetrical with a 0.37 mm thick lens with the upper surface (26a) having a larger radius of curvature than the lower side (26b), an aperture diameter of approximately 0.3 mm, lens distance to sensor of 0.88 mm. The focal zone or area has a diameter of 1 mm.

It is preferable to arrange the optical movement sensor system such that the focal zone is at, immediately adjacent, or close to the mode sensor (18) to minimise the change in lens-to-surface distance between the first and second orientations, thereby minimising the depth of field required to ensure the mouse optics can receive a sufficiently focused image in both orientations.

It will be understood that the optical movement sensor system may be positioned further away from the mode sensor (18) and still function in both modes by using an optical movement sensor system with a large depth of field. However, a larger the depth of field leads to the mouse still detecting movement when it is lifted away from the surface in the pointer mode, which as described previously is undesirable as the user may find it difficult to lift and reposition the mouse without providing pointer movement input to the screen. The need to deactivate pointer movement when the mouse (1) is lifted in the pointer mode restricts the maximum depth of field that can be used. Typically, a depth of field is provided to prevent pointer movement when the mouse base contact plane (8) is lifted a few mm and typically less than five millimetres. Thus, the optical movement sensor system (17) is positioned sufficiently close to the mode sensor (18) to detect mouse movement in both modes within the restricted depth of field.

It will be appreciated that alternative optical systems may be utilised with suitable optimisation of components to ensure focus when the mouse (1) is in both orientations.

The first operation mode in preferred embodiments is a ‘pointer mode’ where movement and/or position data signals indicating movement of the mouse (1) results in pointer movement on the display screen of the host computer (2), i.e. akin to a conventional mouse-computer operation.

The second mode or ‘gesture mode’ is activated when the base contact plane (7) is in a second orientation inclined and/or lifted with respect to the first orientation such that the mode sensor (18) is activated. In the gesture mode, movement detected by the optical system (17) generates data signals interpretable by the computer as swipe gestures.

A “swipe” gesture is a type of user command representing movement of a finger across a touch-screen and typically results in movement of GUI elements such as GUI pages, icons, text, screens or windows. The swipe gesture is one of the primary control methods for tablets, mobile phones and other touch-screen computers. Typical swipe movements include pan (vertical and/or horizontal movement), scroll (vertical movement) and flick (rapid vertical or horizontal movements). The swipe gestures may also include custom gestures such as shapes, alphanumeric characters, symbols or patterns, thereby providing additional controls and potential commands.

An activation of the mode sensor (18) is not only used to activate the second mouse operating mode but is also used to signify a finger touch contact to the computer (2) at a position indicated by the movement sensor (17). Thus, in the second mode, the mouse (1) may operate in an analogous manner to a finger operating on a touch screen, providing finger touch and movement equivalents.

In the second mode, the mouse movement over the work surface (5) detected by the image sensor (16) is received by the computer (2) as a swipe input thereby providing swipe touch-screen commands to the computer (2).

The second mode may also be application-specific, e.g. in a drawing application the second mode could be a drawing mode where the movement data signals are interpreted by the computer (2) as movement of a computer software drawing element such as a digital pen, brush or the like.

Similarly, in Computer Aided Drafting (CAD) software the second mode may be a rotation mode where the movement data signals are interpreted by the computer (2) as 3D rotation or other parameter.

The gesture mode may also be useful to control computer operating systems that are not touch-optimized and can be used for example to provide BACK and FORWARD keyboard commands or the mode sensor (18) activation may be communicated to the computer as a conventional mouse MIDDLE BUTTON CLICK thereby activating a panning mode. Alternatively, activation of the mode sensor (18) may be interpreted as a RIGHT CLICK so that the gesture mode can be used in software applications that are preconfigured for mouse gestures, e.g. Google Chrome, Firefox.

FIGS. 12-14 show another mouse according to a preferred embodiment of the present invention. This mouse (100) is much larger (approximately 12 cm by 6 cm by 4 cm) than the first embodiment and has a more conventional palm-grip type upper body (102).

The mouse (100) also has a scroll wheel (105) and two contact sensors provided in the form of left (103) and right (104) mouse buttons. Supporting feet (108) form a base contact plane (107) and are used to support the mouse as it slides over a work surface.

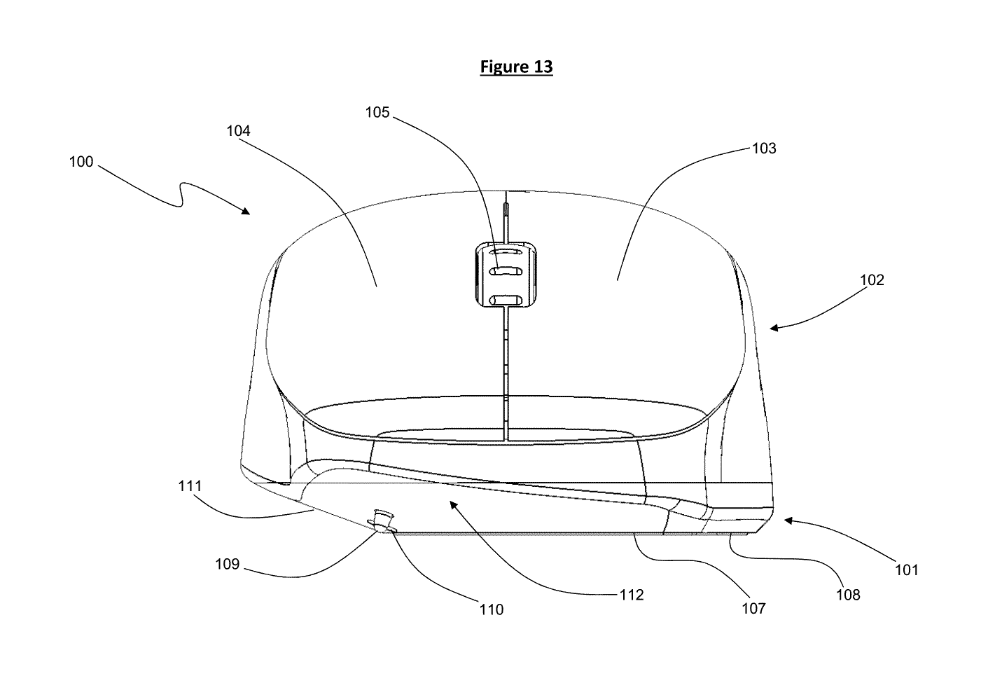

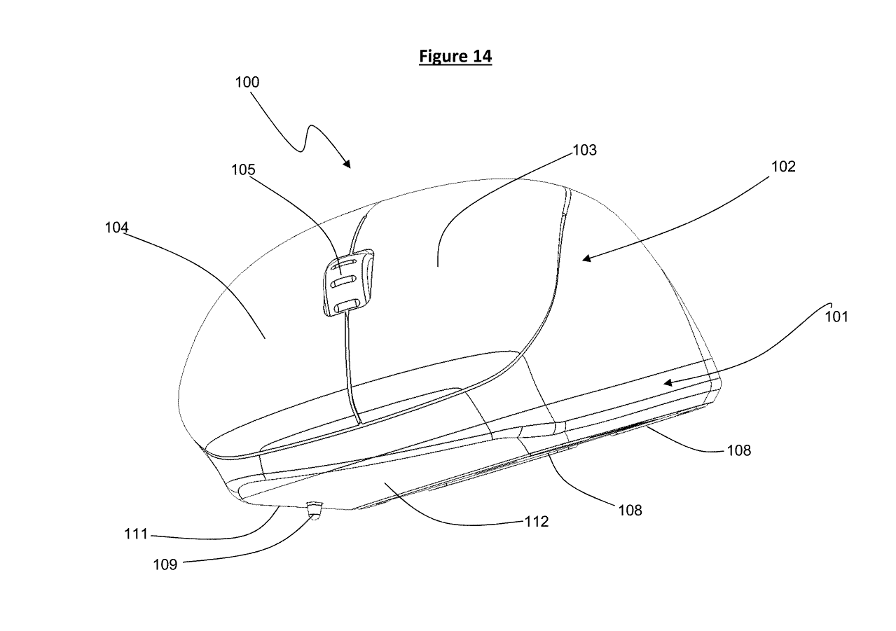

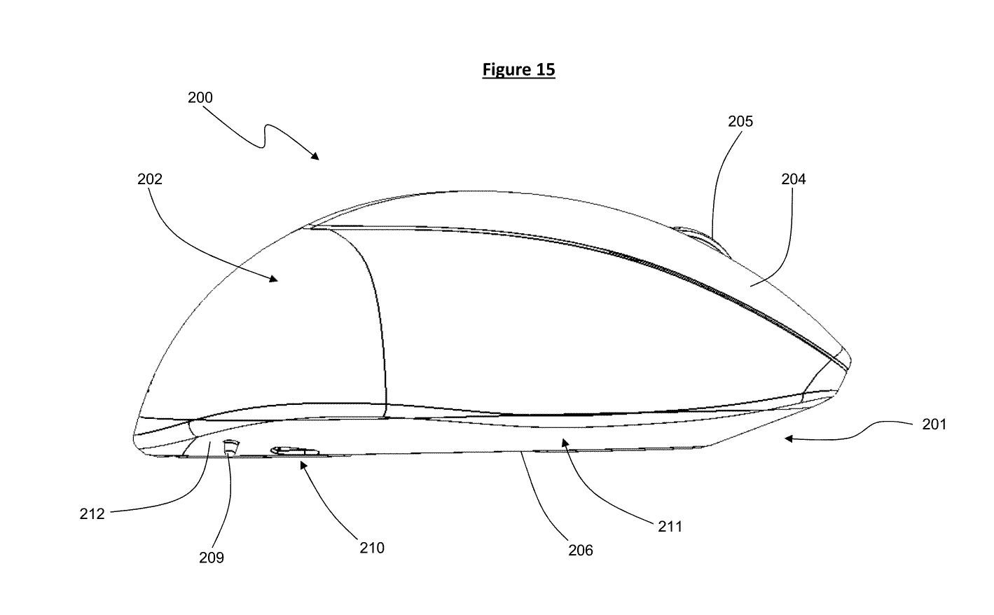

The mouse (100) has a mode sensor (109) positioned to protrude downward from the base (101). An optical movement detection system (110) is provided and configured to provide a focal zone at or very close to the mode sensor (109). The optical system (110) has a similar arrangement to the first mouse embodiment (1) as shown in FIG. 9 and is capable of detecting mouse movement in both first (FIG. 13) and second (FIG. 14) orientations.

The base (101) has a right side portion (111) and forward portion (112) of the underside (106) inclined upward from the base contact plane (107). The underside chamfers (111, 112) provide clearance permitting the mouse (100) to be reoriented to the right and/or forward to activate the mode sensor (109) without interference from other parts of the base (101).

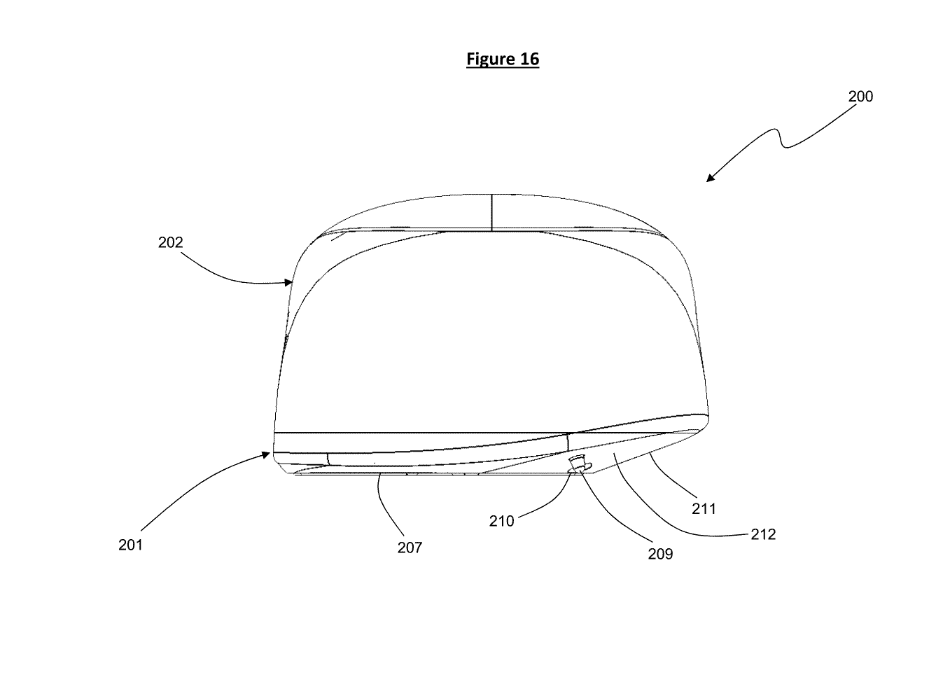

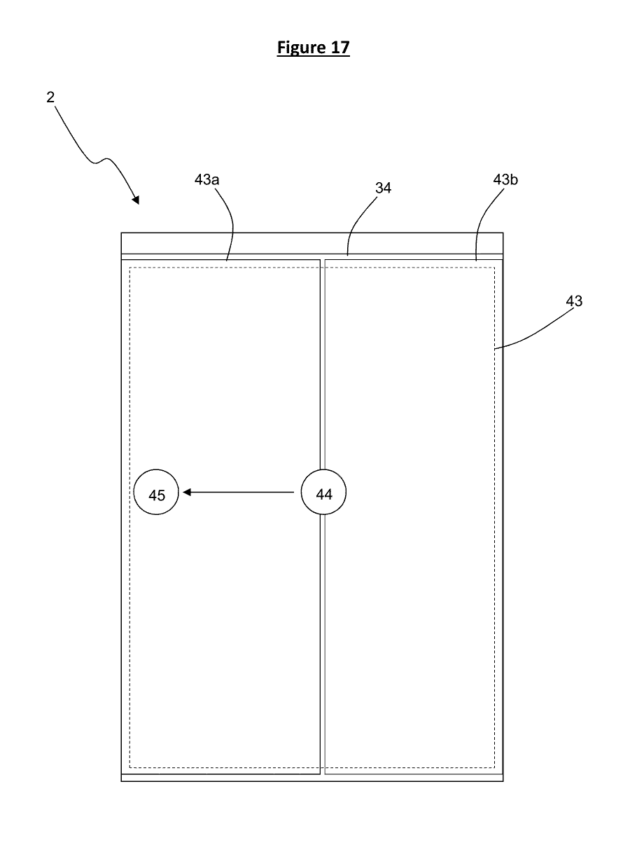

A mouse (200) according to a third embodiment is shown in FIGS. 15 and 16 and has the same components and general shape as the mouse of FIGS. 12-14, i.e. the mouse (200) has a scroll wheel (205) left (203) and right (204) mouse buttons, supporting feet (208) forming a base contact plane (207) and an inclined right side portion (111)

The mouse (200) differs to mouse (100) in that the mode sensor (209) is located toward the rear of the mouse (200) and the mouse has an inclined rearward chamfer (212) to allow the user to tile the mouse backwards and to the right, rather than forwards and to the right as in the previous embodiment (100).

The mice (100, 200) provide a more conventional ‘desktop’ palm-grip shape but provide the same functionality as the smaller mouse (1) through use of two different operating modes, the second mode activated by reorientating the mouse to activate the mode sensor (109, 209).

A touch-based input operating system typically has no need for an on-screen pointer as the user has natural hand-eye coordination with their fingertips over the touch surface. However, when using a mouse the user is typically looking at the display screen and not the mouse which makes coordination difficult without an on-screen pointer being displayed to represent the relative mouse position. Computers are thus typically configured to display on-screen pointer or other appropriate GUI element to provide the user with a visual indication of a position of the mouse (1).

The on-screen pointer is active and displayed in at least the first mode and the mouse (1) is configured to provide pointer coordinates to the computer (2) corresponding to mouse movement. However, in the second mode with the mode sensor activated the computer (2) will interpret the mouse (1, 100, 200) as providing touch events, thus, the on-screen pointer is not visible in the second mode. In this case, the invisible pointer will be referred to as a “finger cursor” representing emulation of a finger in contact with a display screen or touchpad.

The finger cursor position for a touch event is determined by the mouse (1, 100, 200) as a relative location from a start position where the mode sensor (18, 109, 209) and second mode were activated. The finger cursor movement is determined by the movement of the mode sensor (18, 109, 209) over the work surface.

The mouse (1, 100, 200) is configured to indicate a finger cursor ‘start’ or initial position (46) when the mouse (1, 100, 200) exits the first mode and enters the second mode. The start position is typically the centre of the screen, e.g. coordinate determined as X50% Y50% or X0% Y0% depending on how the computer registers position. Subsequent movement is given relative to this start position.

The end of a swipe gesture is registered as the finger cursor reaches the edge of the screen e.g. i.e. the mouse (1) registers a movement to a coordinate within 10% of a screen boundary. The end of a swipe gesture may also be registered when the mouse is lifted form the work surface (5) such that the optical system (17) loses focus. After the end of a swipe gesture the mouse (1, 100, 200) is configured to ‘return’ the finger cursor to the start position, i.e. the current finger touch input signal is stopped and another made at the start position.

This ‘resetting’ of the finger cursor position after swipe gestures allows the user to avoid having to return the mouse (1, 100, 200) to its initial position to start another gesture, instead the user may make a continuous movement which is interpreted by the computer as multiple swipe gestures. This configuration is useful in providing intuitive finger-style navigation for multiple flicks or panning large distances.

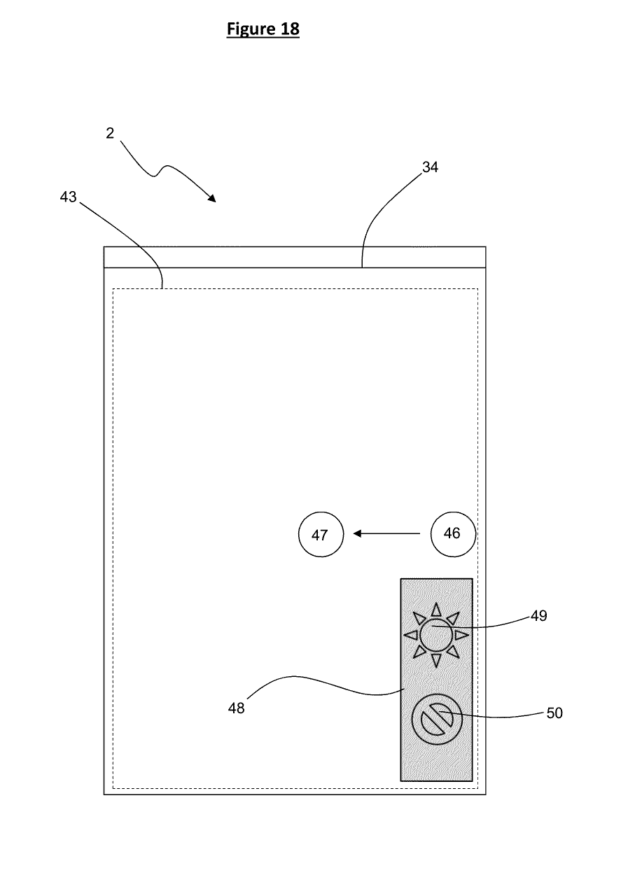

FIG. 17 shows a computer (2) with a display screen (34) displaying portions (43a, 43b) of a multi-page document (43). The dotted rectangle (43) represents an initially displayed page of the document.

The user may activate the gesture mode by tipping the mouse (1, 100, 200) to activate the mode sensor (18, 109, 209) which is interpreted by the computer as a finger touch at the start position (44). Subsequent movement of the mouse (1, 100, 200) to the left is interpreted as a finger swipe gesture to the left to an edge position (47) thereby causing movement of the GUI elements to the left, i.e. document page (43a) moves left to display the next document page (43b). The speed of movement is also detected and translated to the corresponding speed of movement of the GUI elements.

When the mouse (1) is moved further to the left and determines it is further left than the edge position (45), the mouse (1, 100, 200) sends a signal to the computer indicating the finger cursor reset to the start position (44) i.e. indicating to the computer a finger touch at the start position (44). Further movement of the mouse (1, 100, 200) leftwards repeats the procedure allowing the user to make a continuous movement to the left which is interpreted by the computer as multiple left finger swipes. This action displays successive pages of the document (43) in a continuous pan. The user is thus not required to move the mouse (1, 100, 200) back and forth from right to the left as would be the case using a conventional mouse with a touch screen.

The mouse (1, 100, 200) is also configured to indicate a start position as a screen edge by making a ‘double-tap’ with the mode sensor (18, 109, 209), i.e. two successive activations of the mode sensor (18, 109, 209) within a predefined time period. A subsequent swipe gesture will then be used to determine which screen edge the start position is located and is interpreted as movement of a finger from that screen edge, e.g. a subsequent swipe in the left, right, up or down direction will be interpreted as a finger swipe inwards from the right, left, bottom or top screen edge respectively. The mouse (1, 100, 200) can thus be used to quickly create edge finger gestures without requiring the user to move the mouse pointer to the screen edge first.

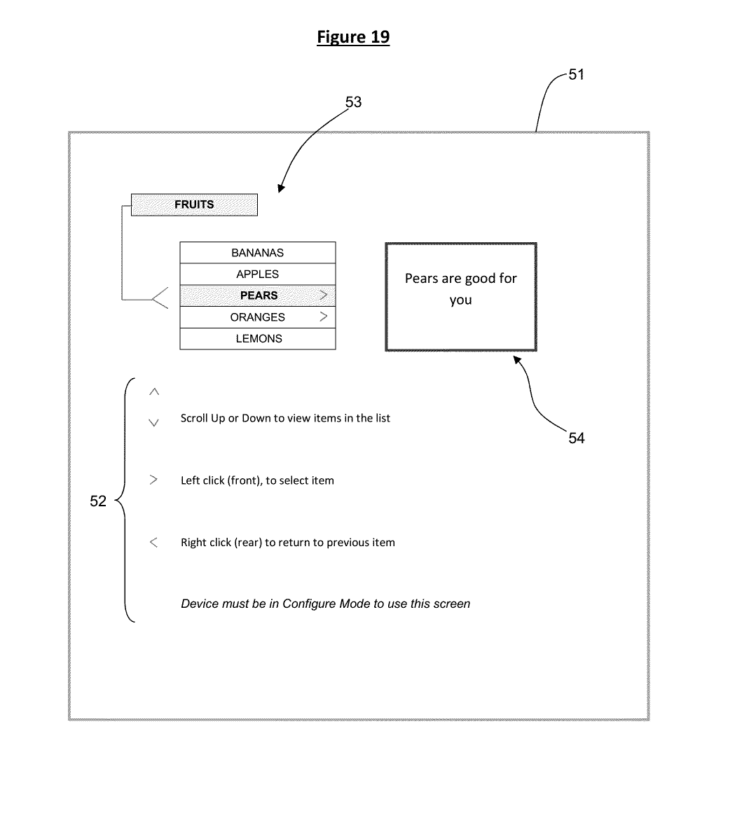

FIG. 18 shows a mode sensor (18, 109, 209) double-tap followed by a left swipe gesture which is interpreted by the computer (2) as a finger swipe starting at the edge ‘start’ position (46) on the right hand side of the screen (34) to an end position (47) toward the centre. This causes a settings bar (48) to be displayed with “brightness” (49) and “cancel” (50) GUI elements.

Other ‘start’ positions may be utilised depending on the application or user configuration.

The mouse (1, 100, 200) may also be configured to emulate various finger gestures through different combinations of buttons and/or swipe gestures, for example, the common ‘pinch-to-zoom’ gesture may be emulated by activating the rear contact sensor (15) when in the gesture mode which causes the mouse (1) to register two finger inputs at a preset distance apart, a subsequent swipe gesture to the left will then indicate reduced distance between finger inputs causing a zoom in while any movement to the right will indicate an increased separation between finger inputs and therefore a zoom-out.

The mouse (1) includes a three-state slider switch (29) on the PCB (21) that a user can operate to switch the mouse (1) between, ON, OFF and CONFIGURE modes, respectively turning the mouse on, off or allowing the mouse firmware to be configured, such as modifications or updates.

Instead of using special software installed on the computer to change mouse settings, the mouse (1, 100, 200) is capable of being modified when in the configure mode through a sequence of button presses and/or scroll wheel movements that change device configuration data stored in an onboard flash memory in the mouse (1, 100, 200). The device configuration data controls how the mouse (1, 100, 200) operates and, through being stored in memory, the user's settings are carried with the mouse (1, 100, 200) and are computer-independent. Examples of mouse settings that may be changed include button function, mouse acceleration settings, LED settings, optical system settings or any other mouse setting.

FIG. 19 shows an exemplary webpage (51) for use in the configuration mode of the mouse (1, 100, 200) or any configurable device. The webpage (51) includes instructions (52) on how to navigate using the mouse controls, a menu GUI (53) indicating the mouse settings (in this case fruit types are used) and a textbox (54) that displays confirmations and/or assistive text.

The device is configured to send signals to the computer indicating combinations of keyboard key-presses which are interpreted by the receiving computer (2) as navigation and/or selection commands on the webpage (51) in an internet browser software application displayed by the computer (2).

The webpage (51) thus enables the device settings to be configured without requiring specific driver software or applications on the computer (2). The device can thus be used and configured on any keyboard compatible computer (2) without requiring software driver installation or other computer configuration. The use of onboard memory ensures that the settings a user chooses when configuring the device are carried with the device and not dependent on the computer (2) being used.

The device (this may be a mouse (1, 100, 200) or any configurable device) when entering the configuration mode is configured to initially send a key sequence that is a unique four character ID. The first two characters are used by the server serving the webpage (51) to identify the device and the last two characters indicate the appropriate menu to display. Example key sequences and their associated devices are displayed in Table 1.

TABLE 1

| Key | | | |
|---|---|---|---|
| Sequence | Text | Parent Key | Helper Text |
| D101 | Mobile Gesture Mouse | 0000 | |
| D1A1 | FOOD | D101 | |
| D1A2 | ANIMALS | D101 | |
| D1A3 | CARS | D101 | |
| D1B1 | VEGES | D1A1 | |
| D1B2 | MEATS | D1A1 | |
| D1B3 | FRUITS | D1A1 | |
| D1C1 | BANANAS | D1B3 | |
| D1C2 | APPLES | D1B3 | |
| D1C3 | PEARS | D1B3 | Pears are good |
| | | | for you |
| D1C4 | ORANGES | D1B3 | |
| D1C5 | LEMONS | D1B3 | |

While in the configuration mode the device will only send Key Sequence codes to the computer in the format AAAAN, where AAAA is a four character key code, N is 0 or 1 (0 means ‘navigate to’, 1 means ‘set to ‘ON’), the comma is the end delimiter. All other device events (e.g. clicks, scrolls, keystrokes, mouse movement, and gestures) will be ‘muted’ such that no signals are sent to the computer.

The following example of this device configuration is made using a mouse (1, 100, 200).

The mouse (1, 100, 200) sends an initial code of D1B21 indicating a mouse device and displaying “MEATS” menu. The following menu is displayed.

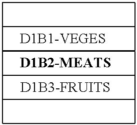

When the user scrolls down or up, the device will respectively send the next (D1B3) or previous (D1B1) key sequence code in the current menu list. If there is no next or previous item in the list, no codes will be sent. The format used will be AAAA0, i.e. navigate to item AAAA.

When the user makes a left click the current menu item code will be sent in the format “AAAA1”, indicating that menu item is to be selected. In this example user scrolls down one unit and then left clicks, therefore sending codes D1B30 then D1B31 and selecting menu item FRUITS.

If the current menu item was a configuration ‘setting state’ it would not have any child menu items. In that case the webpage (51) would make the selected single menu item bold in the list.

The FRUITS item is not a settings value list and instead has child items as shown in the following table.

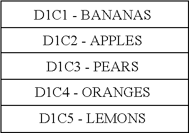

On entering the FRUITS menu the device will send the menu item or setting code for that menu list as is stored on the device, i.e. indicating the stored setting on the device. In this example the stored setting was D1C31 which indicates PEARS setting. The user may then scroll up or down to select the menu item and then left click to select the item to change the setting.

In this example the user scrolls down one item (code D1C40) and left clicks (code D1C41), thereby changing the setting to ORANGES.

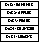 [SMILES: C1CC2C1C1C2C2C3CCC3C12]

The webpage will animate the left to right arrow GUI element on scrolling and then make D1C4 bold and centred in the list on the left click selection.

If the user makes a right button click the device will send a code indicating the parent menu in the format AAAA0, in this case, D1B30 (FRUITS) is sent which is the parent menu list of the fruit menu list currently shown.

The webpage will then animate the right to left arrow GUI element and make D1B3 bold and centred in the list.

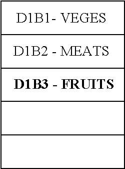 [SMILES: C1CC2C1C1C2C2C3CCC3C12]

The sequence of button presses and scroll wheel movements performed in the configuration mode can be used to trigger data writing, overwriting in the flash memory to change configuration data which controls how the mouse operates. In the example above, the user changed a setting from PEARS to ORANGES. This setting may for example have been swapping the front and rear mouse button functions.

In order for the aforementioned configuration system to function the device to be configured must be capable of being connected to a computer via a wired and/or wireless connection and include:
at least one user input control for receiving user input to control the device;
at least one writeable memory storing device configuration data, the device configuration data being read by the device to determine operational characteristics of the device;
   wherein the device is capable of entering a configuration mode wherein the device is configured to:
send signals to the computer upon receiving user input to the at least one user input control, the signals corresponding to keyboard key-presses, sequences and/or combinations thereof; and
write data to said memory device to modify the device configuration data.

Aspects of the present invention have been described by way of example only and it should be appreciated that modifications and additions may be made thereto without departing from the scope thereof.

1. A computer mouse for use with a computer, said computer mouse including:
a base with a lower surface configured for sliding across a work surface, said lower surface having at least one portion forming part of a base contact plane;
an upper body, extending from the base;
at least one contact sensor;
a movement sensor system, capable of detecting mouse movement relative to said work surface, said movement sensor system including an optical movement sensor system including a light source configured to illuminate the work surface, and an image sensor or array, configured to receive reflected light from said work surface to capture an image of the work surface, wherein successive captured images are compared to determine mouse movement;
a communication system, for communicating computer-readable movement and/or position data signals from the device to a computer, said movement data signals indicating said detected mouse movement and said position data signals indicating a position of the mouse,
the mouse configured to operate in
a first mode when orientated in a first orientation, and
a second mode when orientated in a second orientation wherein said base contact plane is inclined with respect to said first orientation, and
characterised in that said image sensor or array is configured to capture an image of the work surface in both the first and second modes, wherein successive captured images are compared to determine mouse movement in both the first and second modes.

2. A computer mouse as claimed in claim 1, further including at least one mode sensor configured to initiate said first or second mode when the mouse is in said first or second orientation respectively.

3. A computer mouse as claimed in claim 2, wherein said light source is configured to illuminate the work surface at or adjacent said mode sensor.

4. A computer mouse as claimed in claim 2, wherein said mode sensor is configured to initiate said second mode when the mode sensor contacts the work surface.

5. A computer mouse as claimed in claim 2, wherein the mode sensor is configured to initiate said second mode when the mode sensor is forced against the work surface.

6. A computer mouse as claimed in claim 2, wherein the mode sensor includes a projection extending towards said base contact plane.

7. A computer mouse as claimed in claim 6, wherein the mode sensor projection is located above the base contact plane.

8. A computer mouse as claimed in claim 6, wherein the mode sensor projection is releasably connected to the computer mouse.

9. A computer mouse as claimed in claim 6, wherein the mode sensor projection has an outer contact surface for contacting the work surface, the outer contact surface being releasably connected.

10. A computer mouse as claimed in claim 1, including at least one contact sensor located on the upper body, said contact sensor activated by a contact or force applied in a direction toward said base contact plane.

11. The computer mouse as claimed in claim 1, wherein said upper body includes a spine portion projecting upwards from the base further including finger engaging surfaces on either side of the spine such that a user may grip the computer mouse by pinching the spine between a finger and thumb.

12. A computer mouse as claimed in claim 1, configured to provide position data signals calculated using movement data of the mouse as detected by the movement sensing system relative to a start position.

13. A computer mouse as claimed in claim 1, configured in said second mode to provide touch events to said computer.

14. A computer mouse as claimed in claim 1, wherein said computer mouse is configured to translate said movement or position data signals into corresponding movement and/or position touch events.

15. A computer mouse as claimed in claim 13, wherein said computer mouse provides said movement or position data signals to said computer and said computer is configured to translate said data signals into corresponding movement and/or position touch events.

16. A computer mouse as claimed in claim 13, configured to provide a touch event at a predetermined start position upon initiation of said second mode by said mode sensor, said computer mouse generating a position data signal corresponding to said start position.

17. A computer mouse as claimed in claim 13 whereupon initiation of said second mode by a mode sensor said computer mouse is configured to generate a corresponding touch event.

18. A computer mouse as claimed in claim 17, whereupon after two successive touch events, the mouse is configured to provide position data signals to the computer indicating a start position for a touch event corresponding to an edge of a display screen connected to the computer.

19. A computer mouse as claimed in claim 18, configured such that any subsequent swipe gesture performed in said second mode after said successive touch events is provided as position and/or movement data signals indicating a touch event in a corresponding direction away from a given edge and wherein said given edge is inferred by said direction of said swipe gesture.

20. A computer mouse as claimed in claim 13, wherein the computer mouse is configured to provide a position data signal indicating a touch event at a restart position after a mouse movement interpreted as a swipe gesture, said swipe gesture being a movement of the pointing mouse from a start position in said second mode.

21. The computer mouse as claimed in claim 13, wherein the computer mouse is configured to provide data signals to the computer when the mouse moves to a predetermined position, said data signals including a data signal corresponding to an end of a touch event, followed by a position data signal indicating a restart position for a subsequent touch event.

22. The computer mouse as claimed in claim 21 wherein said predetermined position is within a threshold distance of an edge corresponding to an edge of a display screen connected to said computer.

23. The computer mouse as claimed in claim 13, configured to reposition an on-screen pointer or touch event to a start position after a swipe, flick, scroll or custom gesture.

24. The computer mouse as claimed in claim 13, wherein the touch events include a select, swipe, flick, scroll or custom touch gesture.

25. A computer mouse as claimed in claim 13, wherein a start position for a touch event is the position of an on-screen pointer when in said first mode before said second mode is initiated.

26. A computer mouse as claimed in claim 13, wherein a start position is a position corresponding to a centre, corner or edge position of a display screen connected to said computer.

27. A computer mouse as claimed in claim 13, wherein the first mode includes a pointing mode, and in said pointing mode said computer mouse is configured to generate said movement or position data signals indicating on-screen pointer movement or position respectively.
